(19) United States
(12) Patent Application Publication
(10) Pub. No.: US 2024/0234813 A1
(43) Pub. Date: Jul. 11, 2024

(54) POSITIVE ELECTRODE FOR SOLID LITHIUM BATTERY, SOLID LITHIUM BATTERY INCLUDING THE SAME, AND METHOD OF PREPARING POSITIVE ELECTRODE FOR SOLID BATTERY

(71) Applicant: Samsung Electronics Co., Ltd., Suwon-si (KR)

(72) Inventors: Dongjoon LEE, Suwon-si (KR); Bokyung JUNG, Suwon-si (KR)

(21) Appl. No.: 18/316,329

(22) Filed: May 12, 2023

(30) Foreign Application Priority Data
Dec. 2, 2022 (KR) 10-2022-0167032

(51) Int. Cl. H01M 10/0567; H01M 4/38; H01M 4/40; H01M 10/052; H01M 10/0562; H01M 10/0568

(52) U.S. Cl. CPC H01M 10/0567; H01M 4/382; H01M 4/405; H01M 10/052; H01M 10/0562; H01M 10/0568; H01M 2004/028

(57) ABSTRACT

A positive electrode for a solid lithium battery, including: a positive active material; and a catholyte; wherein the catholyte includes a lithium salt, an ionic liquid, and a compound represented by Formula 1, an amount of the lithium salt is about 0.5 moles per liter to about 1.5 moles per liter, and the catholyte is a gel

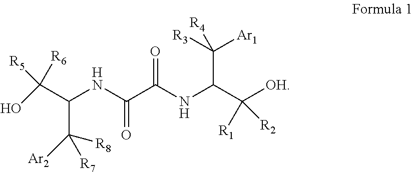

### CROSS-REFERENCE TO RELATED APPLICATION

This application is based on and claims priority under 35 U.S.C. § 119 to Korean Patent Application No. 10-2022-0167032, filed on Dec. 2, 2022, in the Korean Intellectual Property Office, the content of which is herein incorporated by reference in its entirety.

### BACKGROUND

### 1. Field

The disclosure relates to a positive electrode for a solid lithium battery, a solid lithium battery including the same, and a method of preparing a positive electrode for a solid battery. The disclosure further relates to a catholyte and a method of preparing the catholyte.

### 2. Description of the Related Art

Lithium batteries may provide improved specific energy (Wh/kg) and/or energy density (Wh/cc).

Lithium batteries may include a solid electrolyte to enhance stability. When a lithium battery employs a solid electrolyte, interfacial resistance between a positive electrode and the solid electrolyte may increase. Thus, the need remains for improved materials for solid lithium batteries.

### SUMMARY

A lithium battery may further include a catholyte in order to reduce interfacial resistance between a positive electrode and a solid electrolyte. The catholyte may be, for example, a liquid. A liquid catholyte may reduce interfacial resistance between the positive electrode and the solid electrolyte, but liquid leakage may occur. During charging and discharging of a lithium battery, for example, the catholyte may bypass a solid electrolyte layer, transport along a surface of the solid electrolyte layer, or diffuse to a negative electrode, due to liquid leakage of the catholyte. Side reactions may occur due to contact between the catholyte and the negative electrode, and deterioration of the negative electrode may be accelerated. As a result, cycle characteristics of a lithium battery including a catholyte are deteriorated. Therefore, there is a need for an improved positive electrode material capable of preventing deterioration of a lithium battery by suppressing contact between the catholyte and the negative electrode.

An aspect is to provide a novel positive electrode for a solid lithium battery.

Another aspect is to provide a solid lithium battery including the positive electrode for a solid lithium battery.

Still another aspect is to provide a method of preparing the positive electrode for a solid lithium battery.

Additional aspects will be set forth in part in the description which follows and, in part, will be apparent from the description, or may be learned by practice of the presented embodiments of the disclosure.

According to an aspect of the disclosure, provided is a positive electrode for a solid lithium battery including a positive active material and a catholyte, wherein the catholyte includes a lithium salt, an ionic liquid, and a compound represented by Formula 1, an amount of the lithium salt is about 0.5 moles per liter (M) to about 1.5 M, and the catholyte is a gel

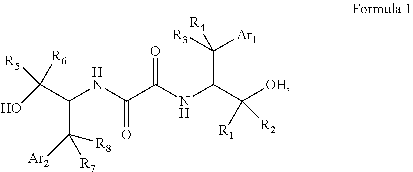

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

According to another aspect of the disclosure, provided is a solid lithium battery including: the positive electrode according to the above aspect; a negative electrode; and an electrolyte layer arranged between the positive electrode and the negative electrode, wherein the electrolyte layer includes a solid electrolyte.

According to another aspect of the disclosure, provided is a catholyte for a solid lithium battery, wherein the catholyte includes a lithium salt, an ionic liquid, and a compound represented by Formula 1, an amount of the lithium salt is about 0.5 M to about 1.5 M, and the catholyte is a gel

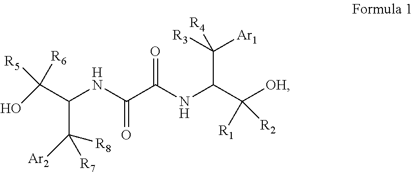

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

According to another aspect of the disclosure, provided is a method of preparing a positive electrode for a solid lithium battery, the method including: providing a catholyte film, arranging the catholyte film on one surface of the positive active material layer, liquefying the catholyte film to impregnate into the positive active material with the catholyte and form a impregnated positive active material, and cooling the impregnated positive active material to gel the catholyte impregnated in the positive active material layer and prepare the positive active material, wherein the catholyte includes a lithium salt, an ionic liquid, and a compound represented by Formula 1, an amount of the lithium salt is about 0.5 M to about 1.5 M, and the catholyte is a gel

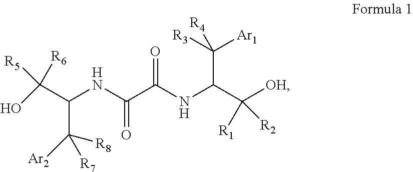

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

Also disclosed is a method of preparing a catholyte, the method including: combining a lithium salt, an ionic liquid, and a compound represented by Formula 1,

wherein an amount of the lithium salt is about 0.5 moles per liter to about 1.5 moles per liter;
liquefying the composition; and cooling the liquefied composition to prepare the catholyte in the form of a gel,

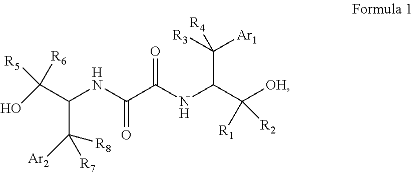

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 schematically illustrates an embodiment of a structure of a solid secondary battery;

FIG. 2 schematically illustrates an embodiment of a structure of a solid secondary battery;

FIG. 3 is a schematic diagram of solid lithium batteries of Example 1 and Comparative Example 1;

FIG. 4 is a schematic diagram of a solid lithium battery of Comparative Example 1-2; and

FIG. 5 is a graph of capacity relative to 0.1 C (%) versus current density (mA/cm²) showing high-rate characteristics of the solid lithium batteries of Example 1, Comparative Example 1, and Comparative Example 1-2.

### DETAILED DESCRIPTION

Reference will now be made in detail to embodiments, embodiments of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of at least one of the associated listed items. “Or” means “and/or.” Expressions such as “at least one of,” when preceding a list of elements, modify the entire list of elements and do not modify the individual elements of the list.

The disclosure described hereinafter may be modified in various ways, and may have many examples, and thus, certain examples are illustrated in the drawings, and are described in detail in the specification. However, this does not intend to limit the disclosure within particular embodiments, and it should be understood that the disclosure includes all the modifications, equivalents, and replacements within the technical scope of the disclosure.

Terms used herein were used to describe particular examples, and not to limit the disclosure. As used herein, the singular of any term includes the plural, unless the context otherwise requires. The expression of “include” or “have”, used herein, indicates an existence of a characteristic, a number, a phase, a movement, an element, a component, a material, or a combination thereof, and it should not be construed to exclude in advance an existence or possibility of existence of at least one of other characteristics, numbers, movements, elements, components, materials, or combinations thereof. As used herein, “/” may be interpreted to mean “and” or “or” depending on the context.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

In the drawings, a thickness may be enlarged or reduced to clearly represent various layers and regions. The same reference numerals refer to similar portions throughout the disclosure. As used herein throughout the disclosure, when a layer, a membrane, a region, or a plate is described to be “on” or “above” something else, it not only includes the case in which it is directly on, but also the case when other portion(s) are present in-between. Terms like “first”, “second”, and the like may be used to describe various components, but the components are not limited by the terms. The terms are used merely for the purpose of distinguishing one component from other components.

“Metal” as used herein, includes both metals and metalloids, such as silicon and germanium, in an elemental or ionic state.

“Alloy” as used herein, means a mixture of two or more metals.

“Positive active material” as used herein means a positive electrode material capable of undergoing lithiation and delithiation.

“Negative active material” as used herein means a negative electrode material capable of undergoing lithiation and delithiation.

“Lithiation” and “to lithiate” as used herein refer to a process of adding lithium to a positive active material or a negative active material.

“Delithiation” and “to delithiate” as used herein refer to a process of removing lithium from a positive active material or a negative active material.

“Charge” and “to charge” as used herein refer to a process of providing electrochemical energy to a battery.

“Discharge” and “to discharge” as used herein refer to a process of removing electrochemical energy from a battery.

“Positive electrode” and “cathode” as used herein refer to an electrode in which electrochemical reduction and lithiation occur during a discharging process.

“Negative electrode” and “anode” as used herein refer to an electrode in which electrochemical oxidation and delithiation occur during a discharging process.

“Substituted” as used herein means that the compound or group is substituted with at least one (e.g., 1, 2, 3, or 4) substituent, and the substituents are independently a hydroxyl (—OH), a halogen (F, Br, Cl, I), a C1-C30 alkoxy, a C1-C9 haloalkoxy, an oxo (═O), a nitro (—NO₂), a cyano (—CN), an amino (—NH₂), an azido (—N₃), an amidino (—C(═NH)NH₂), a hydrazino (—NHNH₂), a hydrazono (═N—NH₂), a carbonyl (—C(═O)—), a carbamoyl group (—C(O)NH₂), a sulfonyl group (—S(═O)₂—), a sulfamoyl group, a thiol group (—SH), a thiocyano (—SCN), a tosyl group (CH₃C₆H₄SO₂—), a carboxylic acid group (—C(═O)OH), a carboxylic C1 to C6 alkyl ester group (—C(═O)OR wherein R is a C1 to C6 alkyl group), a carboxylic acid salt group (—C(═O)OM) wherein M is an organic or inorganic cation, a sulfonic acid group (—SO₃H₂), a sulfonic mono- or dibasic salt group (—SO₃MH or —SO₃M₂ wherein M is an organic or inorganic cation), a phosphoric acid group (—PO₃H₂), a phosphoric acid mono- or dibasic salt group (—PO₃MH or —PO₃M₂ wherein M is an organic or inorganic cation), a C1 to C30 alkyl group, a halogen atom substituted C1-C12 alkyl group (for example, CF₃, CHF₂, CH₂F, or CCl₃), a C3 to C12 cycloalkyl group, a C2 to C30 alkenyl group, a C5 to C12 cycloalkenyl group, a C2-C30 heteroaryloxy group, a C6-C30 heteroaryloxyalkyl group, a C2 to C30 alkynyl group, a C6 to C30 aryl group, a C7 to C13 arylalkyl group, a C4 to C12 heterocycloalkyl group, or a C3 to C30 heteroaryl group instead of hydrogen, provided that the substituted atom's normal valence is not exceeded. The indicated number of carbon atoms for any group herein is exclusive of any substituents.

In this specification, a “particle size” of a particle indicates an average diameter when the particle is spherical and indicates an average length of a major axis when the particle is non-spherical. The particle size of may be measured using a particle size analyzer (PSA). The “particle size” of particles may be, for example, an average particle size. The average particle diameter is a median particle diameter (D50) unless explicitly stated otherwise. The median particle diameter (D50) is a particle size corresponding to a cumulative value of 50% calculated from a side of a particle with the smallest particle size in a cumulative distribution curve of particle sizes in which particles are accumulated in order of the particle sizes from the smallest particle to the largest particle. A cumulative value may be, for example, a cumulative volume. The median particle diameter (D50) may be measured, for example, by a laser diffraction method.

Hereinafter, a positive electrode for a solid lithium battery according to an embodiment, a solid lithium battery including the same, and a method of preparing the positive electrode will be described in more detail.

### Positive Electrode

A positive electrode for a solid lithium battery according to an embodiment includes a positive active material; and a catholyte, wherein the catholyte includes a lithium salt, an ionic liquid, and a compound represented by Formula 1, an amount of the lithium salt is about 0.5 moles per liter (M) to about 1.5 M, and the catholyte is a gel,

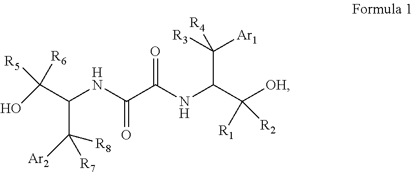

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms, 6 to 18 carbon atoms, or 10 to 14 carbon atoms that are unsubstituted or substituted with a halogen; an aryl group having 5 to 20 carbon atoms, 6 to 18 carbon atoms, or 10 to 14 carbon atoms that are unsubstituted or substituted with an alkyl group having 1 to 3 carbon atoms, a heteroaryl group having 2 to 10 carbon atoms, 6 to 18 carbon atoms, or 10 to 14 carbon atoms that are unsubstituted or substituted with a halogen, or a heteroaryl group having 2 to 10 carbon atoms that are unsubstituted or substituted with an alkyl group having 1 to 3 carbon atoms.

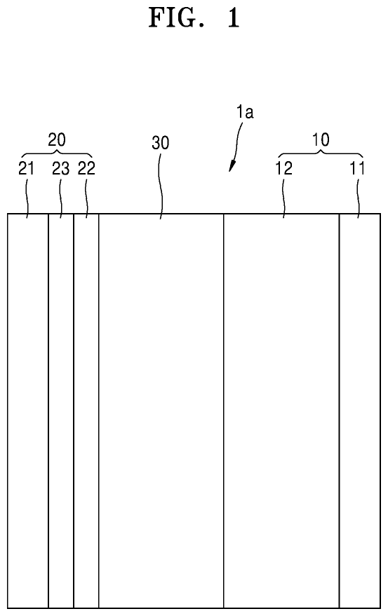

Referring to FIGS. 1 to 4, a solid lithium battery 1 includes a positive electrode 10, the positive electrode 10 includes a positive current collector 11 and a positive active material layer 12, and the positive active material layer 12 includes a positive active material and a catholyte.

### Positive Electrode: Catholyte

A catholyte has a gel state by including a lithium salt in an amount of a certain range, an ionic liquid, and a compound represented by Formula 1. A catholyte in a gel state has very low flowability at room temperature (25° C.). The catholyte in a gel state, i.e., a gel catholyte, may change its shape by an external force at room temperature, for example, but may not change its shape in an absence of an external force. The catholyte in a gel state may maintain a constant shape at room temperature. The catholyte in a gel state may, for example, substantially not change its shape for 24 hours at 25° C. on a substrate tilted at 45° from a horizontal surface at room temperature. The catholyte in a gel state may, for example, have a single phase. The catholyte in a gel state may, for example, not be a mixture of a gel and a liquid, and may be a single phase. On the other hand, a catholyte in a liquid state does not maintain a constant shape at room temperature and has very high flowability. In a positive electrode including a liquid electrolyte, the liquid electrolyte is, for example, easily leaked out of the positive electrode.

When a positive electrode includes a gel catholyte, leakage of the catholyte out of the positive electrode may be suppressed. Therefore, movement of the catholyte leaked from the positive electrode to the negative electrode, or passing around a solid electrolyte layer, may be suppressed. Therefore, a side reaction between the catholyte and the negative electrode, for example, lithium metal, may be suppressed. In addition, deterioration of the solid lithium battery is suppressed and cycle characteristics of the solid lithium battery are improved. When the catholyte has a gel state, even when cracks occur in the solid electrolyte layer, movement of the catholyte to the negative electrode along the cracks may be suppressed. Therefore, structural stability of the solid lithium battery may be enhanced. When an amount of a lithium salt satisfies the above-described range, the catholyte has a stable gel state. When the amount of a lithium salt is too low or too high, a gel-state catholyte cannot be obtained.

The catholyte may be a liquid at a temperature of, for example, 80° C. or greater, 85° C. or greater, 90° C. or greater, or 95° C. or greater, such as about 80° C. to about 115° C., about 85° C. to about 110° C., about 90° C. to about 105° C. The catholyte may be a gel at a temperature of, for example, less than 80° C., less than 70° C., less than 60° C., less than 50° C., less than 40° C., or less than 30° C., such as about 10° C. to about 80° C., about 20° C. to about 70° C., about 30° C. to about 60° C. The catholyte may be thermally phase switchable. The catholyte may be, for example, a gel at room temperature, and a liquid at 80° C. or greater.

At a temperature of 80° C. or greater, a catholyte in a liquid state is thoroughly impregnated at an interface between the positive electrode and the solid electrolyte layer, and thus interfacial resistance between the positive electrode and the solid electrolyte layer may be reduced. After the catholyte is impregnated at the interface between the positive electrode and the solid electrolyte layer, the liquid electrolyte is gelled by cooling, and thus, an increase of the interfacial resistance between the positive electrode and the solid electrolyte layer may be suppressed. A catholyte in a gel state may have, for example, elasticity. Therefore, the catholyte may effectively maintain an ionic connection between the positive electrode and the solid electrolyte layer while effectively accommodating a volume change of the positive electrode during charging and discharging processes of a solid lithium battery. The catholyte may effectively suppress the increase in interfacial resistance between the positive electrode and the solid electrolyte layer during charging and discharging processes of a solid lithium battery.

The compound represented by Formula 1 may be, for example, a compound represented by Formula 2:

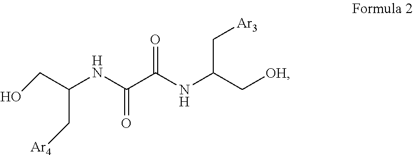

wherein in Formula 2, Ar₃, and Ar₄ are each independently an aryl group having 5 to 20 carbon atoms, 6 to 18 carbon atoms, or 10 to 14 carbon atoms that are unsubstituted or substituted with a halogen, an aryl group having 5 to 20 carbon atoms, 6 to 18 carbon atoms, or 10 to 14 carbon atoms that are unsubstituted or substituted with an alkyl group having 1 to 3 carbon atoms, a heteroaryl group having 2 to 10 carbon atoms or 4 to 8 carbon atoms that are unsubstituted or substituted with a halogen, or a heteroaryl group having 2 to 10 carbon atoms or 4 to 8 carbon atoms that are unsubstituted or substituted with an alkyl group having 1 to 3 carbon atoms.

The compound represented by Formula 1 may be, for example, a compound represented by a compound Formulas 3 to 10, or a combination thereof:

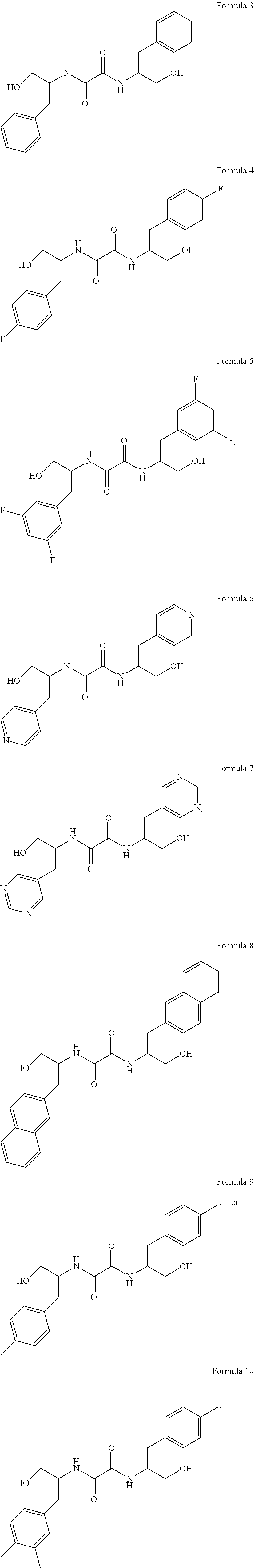

When a catholyte includes a compound represented by a compound of Formulas 1 to 10, or a combination thereof, the catholyte may have a gel state at a temperature below 80° C., and a liquid state at a temperature of 80° C. or greater.

The compound represented by Formulas 1 to 10 may be, for example, self-assembled in the catholyte. When the compound represented by Formulas 1 to 10 is self-assembled in the catholyte, for example, structural regularity may be given inside the catholyte. When the compound represented by Formulas 1 to 10 is self-assembled in the catholyte, for example, a two-dimensional structure, a three-dimensional structure, or a combination thereof may be included inside the catholyte. When the compound represented by Formulas 1 to 10 is self-assembled in the catholyte, the catholyte may be, for example, in a gel state.

A molecular weight of the compound represented by Formulas 1 to 10 may be, for example, less than 1,000 Daltons (Da), less than 900 Da, or less than 800 Da. A molecular weight of the compound represented by Formulas 1 to 10 may be, for example, about 100 Da to about 1,000 Da, about 150 Da to about 900 Da, or about 200 Da to about 800 Da. When the compound represented by Formulas 1 to 10 has a molecular weight in this range, a phase change between a gel state and a liquid state may be performed more reversibly.

An amount of the compound represented by Formulas 1 to 10 may be, for example, about 2 weight percent (wt %) to about 10 wt %, about 3 wt % to about 10 wt %, about 4 wt % to about 10 wt %, or about 5 wt % to about 10 wt %, with respect to a total weight of the catholyte. When an amount of the compound represented by Formulas 1 to 10 is too low, it may be difficult to form a gel. When an amount of the compound represented by Formulas 1 to 10 is too high, ionic conductivity of the catholyte may decrease.

The catholyte may include a lithium salt, and the lithium salt may include at least one of LiPF₆, LiBF₄, LiCF₃SO₃, LiC₂F₅SO₃, LiC₄F₉SO₃, LiN(SO₂F)₂ (LiFSI), LiN(CF₃SO₂)₂ (LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, a compound represented by Formulas 11 to 14, or a combination thereof:

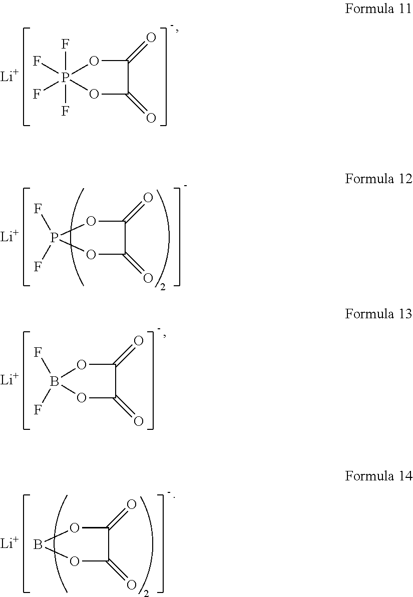

A combination comprising at least one of the foregoing may be used.

The catholyte may include a lithium salt, and an amount of the lithium salt may be, for example, about 0.6 molar (M) to about 1.4 M, about 0.7 M to about 1.3 M or about 0.8 M to about 1.2 M. When the amount of a lithium salt is too low, ionic conductivity of the catholyte may decrease. When the amount of a lithium salt is too high, the catholyte may maintain a liquid state and a gel state may not be obtained.

The catholyte may include an ionic liquid, and the ionic liquid may, for example, include a compound represented by Formulas 15, 16, or a combination thereof:

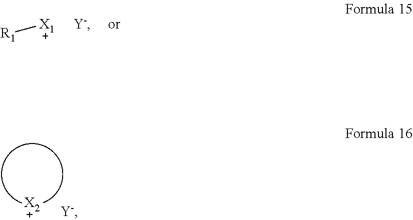

wherein in Formula 15,
X₁ is —N(R₂)(R₃)(R₄) or —P(R₂)(R₃)(R₄); and
R₁, R₂, R₃, and R₄ are each independently a C1-C30 alkyl group unsubstituted or substituted with a halogen, a C1-C30 alkoxy group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, and a C2-C100 alkylene oxide group unsubstituted or substituted with a halogen, and

### in Formula 16,

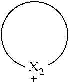 [0063] is a heterocycloalkyl ring or heteroaryl ring containing 1 to 3 heteroatoms and 2 to 30 carbon atoms, the ring being unsubstituted or substituted by a substituent;
X₂ is —N(R₅)(R₆), —N(R₅)═, —P(R₅)(R₆), or —P(R₅)═;
the substituent with which the ring is substituted, R₅, and R₆ are each independently hydrogen, a C1-C30 alkyl group unsubstituted or substituted with a halogen, a C1-C30 alkoxy group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, and a C2-C100 alkylene oxide group unsubstituted or substituted with a halogen; and
Y⁻ is an anion.

The catholyte may include an ionic liquid, and the ionic liquid may, for example, include a compound represented by Formulas 17, 18, or a combination thereof:

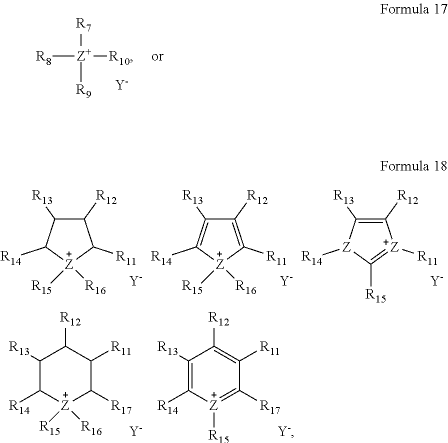

wherein in Formula 17,
Z is N or P; and
R₇, R₈, R₉, and R₁₀ are each independently a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen, and

### in Formula 18,

Z is N or P;
R₁₁, R₁₂, R₁₃, R₁₄, R₁₅, R₁₆, and R₁₇ are each independently hydrogen, a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen; and
Y⁻ is an anion.

In Formulas 15 to 18, the anion may include, for example, BF₄⁻, PF₆⁻, AsF₆⁻, SbF₆⁻, AlCl₄⁻, HSO₄⁻, ClO₄⁻, CH₃SO₃⁻, CF₃CO₂⁻, Cl, Br, I⁻, BF₄⁻, SO₄⁻, PF₆⁻, ClO₄⁻, (bis(oxalate)borate)⁻ (BOB⁻), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, or a combination thereof.

The catholyte may include an ionic liquid, and the ionic liquid may include, for example, 1-methyl-1-propylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, or a combination thereof.

When the catholyte includes the ionic liquid, disadvantages of non-aqueous solvents in the art, such as side reactions between the positive active material and the solvent, and vaporization of the solvent, may be suppressed.

The catholyte may not include, for example, a polymer binder or an oligomer binder. The catholyte may not include, for example, an oligomer having a molecular weight of 1,000 Daltons (Da) or greater, a polymer having a molecular weight of 1,000 Da or greater, or a combination thereof. The catholyte may be free of, for example, an oligomer, a polymer, or a combination thereof, having a molecular weight of 1,000 Da or greater, such as about 1,000 Da to about 2,000,000 Da, about 2,000 Da to about 1,500,000 Da, about 3,000 Da to about 1,000,000 Da, about 5,000 Da to about 500,000 Da. “Free” as used herein means that the content of the oligomer, polymer, or combination thereof is excluded from the catholyte. In an aspect, “essentially free” means that the content of the oligomer, polymer, or combination thereof is less than about 0.0001 weight percent (wt %) to about 0.1 wt %, about 0.001 wt % to about 0.01 wt %, or about 0.05 wt %, based on a total weight of the catholyte. Molecular weight can be determined using gel permeation chromatography (GPC) with polystyrene standards as described in Williams and Ward, J. Polymer. Sci., Polymer. Letters, 6, 621 (1968) or by other methods known in the art.

When the catholyte does not include a polymer or oligomer used as a binder, ion conductivity of the catholyte may be further enhanced. Compared to a catholyte in the art that increases viscosity by including a binder, the catholyte according to an embodiment including the compound of Formula 1, a lithium salt, and an ionic liquid maintains a gel state without a binder, and therefore, the catholyte may provide enhanced ionic conductivity compared to the catholyte in the art including a binder.

The catholyte may exclude, for example, and may be free of a non-aqueous solvent. The catholyte may not include a non-aqueous solvent such as a hydrocarbon-based solvent, an ether-based solvent, or a carbonate-based solvent. When the catholyte does not include a non-aqueous solvent, side reactions such as gas generation may be effectively suppressed.

A positive electrode may exclude, for example, and may be free of an inorganic solid electrolyte. Since the positive electrode includes an organic electrolyte as a catholyte, an additional inorganic solid electrolyte may not be included. The positive electrode may not additionally include an inorganic solid electrolyte such as sulfide-based solid electrolytes, oxide-based solid electrolytes, and halide-based solid electrolytes.

### Positive Electrode: Positive Active Material Layer

Referring to FIGS. 1 to 4, the positive electrode 10 includes a positive current collector 11, and a positive active material layer 12 arranged on one surface of the positive current collector 11. The positive active material layer 12 includes a positive active material.

Any suitable positive active material used in lithium batteries may be used without limitation. For example, the positive active material may be lithium transition metal oxide or transition metal sulfide. For example, one or more of a complex oxide of lithium and a metal selected from cobalt, manganese, nickel, and combinations thereof may be used, for specific examples, any compound represented by any one of the following formulas may be used: LiₐA_{1-b}B′_{b}D₂ (wherein 0.90≤a≤1.8 and 0≤b≤0.5); LiₐE_{1-b}B′_{b}O_{2-c}D_{c} (wherein 0.90≤a≤1.8, 0≤b≤0.5, and 0≤c≤0.05); LiE_{2-b}B′_{b}O_{4-c}D_{c} (wherein 0≤b≤0.5 and 0≤c≤0.05); LiₐNi_{1-b-c}CO_{b}B′_{c}D_{α}(wherein 0.90≤a≤1.8, 0≤b≤0.5, 0≤c≤0.05, and 0<α≤2); LiₐNi_{1-b-c}CO_{b}B′_{c}O_{2-α}F′_{α} (wherein 0.90≤a≤1.8, 0≤b≤0.5, 0≤c≤0.05, and 0<α<2); LiₐNi_{1-b-c}CO_{b}B′_{c}O_{2-α}F′₂ (wherein 0.90≤a≤1.8, 0≤b≤0.5, 0≤c≤0.05, and 0<α<2); LiₐNi_{1-b-c}Mn_{b}B′_{c}D_{α} (wherein 0.90≤a≤1.8, 0≤b≤0.5, 0≤c≤0.05, and 0<α≤2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}O_{2-α}F′₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GₑO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₂; LiI′O₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄. In the formulas, A may be Ni, Co, Mn, or a combination thereof; B′ may be Al, Ni, Co, Mn, Cr, Fe, Mg, Sr, V, a rare earth element, or a combination thereof; D may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. For example, LiCoO₂, LiMnₓO₂ₓ (wherein x=1, 2), LiNi₁₋ₓMnₓO₂ₓ (wherein 0<x<1), Ni_{1-x-y}CoₓMn_{y}O₂ (wherein 0≤x≤0.5, 0≤y≤0.5), LiFePO₄, TiS₂, FeS₂, TiS₃, or FeS₃ may be used.

The positive active material may be a compound represented by Formulas 19 to 26, or a combination thereof:

LiₐCoₓM_{y}O_{2-b}A_{b}, Formula 19

wherein in Formula 19,
1.0≤a≤1.2, 0≤b≤0.2, 0.9≤x≤1, 0≤y≤0.1, and x+y=1;
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof; and
   A is F, S, Cl, Br, or a combination thereof,

LiₐNiₓCo_{y}M_{z}O_{2-b}A_{b}, Formula 20

wherein in Formula 20,
1.0≤a≤1.2, 0≤b≤0.2, 0.8≤x<1, 0≤y≤0.3, 0<z≤0.3, and x+y+z=1;
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof; and
A is F, S, Cl, Br, or a combination thereof,

LiNiₓCo_{y}Mn_{z}O₂, Formula 21

LiNiₓCo_{y}Al_{z}O₂, Formula 22
wherein in Formula 21 and Formula 22, 0.8≤x≤0.95, 0<y≤0.2, 0<z≤0.2, and x+y+Z=1,

LiNiₓCo_{y}Mn_{z}Al_{w}O₂, Formula 23
wherein in Formula 23, 0.8≤x≤0.95, 0≤y≤0.2, 0<z≤0.2, 0<w≤0.2, and x+y+z+w=1,

LiₐNiₓMn_{y}M′_{z}O_{2-b}A_{b}, Formula 24

wherein in Formula 24,
1.0≤a≤1.2, 0≤b≤0.2, 0<x≤0.3, 0.5≤y<1, 0<z≤0.3, and x+y+z=1;
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof; and
A is F, S, Cl, Br, or a combination thereof,

LiₐM1ₓM2_{y}PO_{4-b}X_{b}, Formula 25

wherein in Formula 25, 0.90≤a≤1.1, 0≤x≤0.9, 0≤y≤0.5, 0.9<x+y<1.1, and 0≤b≤2;
M1 is chromium (Cr), manganese (Mn), iron (Fe), cobalt (Co), nickel (Ni), copper (Cu), zirconium (Zr), or a combination thereof;
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or combinations thereof; and X is O, F, S, P or combinations thereof,

LiₐM3_{z}PO₄, Formula 26
wherein in Formula 26, 0.90≤a≤1.1, and 0.9≤z≤1.1; and
M3 is chromium (Cr), manganese (Mn), iron (Fe), cobalt (Co), nickel (Ni), copper (Cu), zirconium (Zr), or a combination thereof.

The positive active material layer 12 may further include a conductive material and a binder.

The conductive material may include, for example, carbon black, carbon fiber, graphite, or a combination thereof. The carbon black may be, for example, acetylene black, ketjen black, super P carbon, channel black, furnace black, lamp black, thermal black, or combinations thereof. Graphite may be natural graphite or artificial graphite. Combinations including at least one of the above-described may be used. The positive electrode may additionally include an additional conductive material other than the carbonaceous conductive material described above. The additional conductive material may be electrically conductive fibers such as metal fibers; metal powders such as fluorocarbon powder, aluminum powder, or nickel powder; conductive whiskers such as zinc oxides or potassium titanate; or a polyethylene derivative. Combinations including at least one of the above-described additional conductive materials may be used. An amount of the conductive material may be about 1 part by weight to about 10 parts by weight, or about 2 parts by weight to about 7 parts by weight, with respect to 100 parts by weight of the positive active material. When the amount of the conductive material is in this range, for example, in a range of about 1 part by weight to about 10 parts by weight, electrical conductivity of the positive electrode may be adequate.

A binder may improve adhesion between components of the positive electrode and adhesion of the positive electrode to the current collector. Examples of binders may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or a combination thereof. An amount of the binder may be about 1 part by weight to about 10 parts by weight, or about 2 parts by weight to about 7 parts by weight, with respect to 100 parts by weight of the positive active material. When the amount of the binder is within these ranges, adhesion of the positive active material layer to the positive current collector is further improved, and a decrease in energy density of the positive active material layer may be suppressed.

### Positive Electrode: Positive Current Collector

A positive electrode 10 includes a positive current collector 11. The positive current collector 11 may be omitted.

The positive current collector 11 includes, for example, a metal substrate. For the metal substrate, a plate or foil made of aluminum (Al), indium (In), copper (Cu), magnesium (Mg), stainless steel, titanium (Ti), iron (Fe), cobalt (CO), nickel (Ni), zinc (Zn), germanium (Ge), lithium (Li), or an alloy thereof, may be used. The positive electrode collector may be omitted. The positive current collector may further include a carbon layer (not shown) arranged on one surface or both surfaces of the metal substrate. When a carbon layer is additionally arranged on the metal substrate, it is possible to prevent metal of the metal substrate from being corroded by the solid electrolyte included in the positive electrode layer, and to reduce interfacial resistance between the positive active material layer and the positive current collector. A thickness of the carbon layer may be, for example, about 0.1 micrometer (μm) to about 5 μm, about 0.1 μm to about 3 μm, or about 0.1 μm to about 1 μm. When the carbon layer is too thin, it may be difficult to completely block contact between the metal substrate and the solid electrolyte. When the carbon layer is too thick, energy density of an all-solid secondary battery may be declined. The carbon layer may include amorphous carbon or crystalline carbon.

### Solid Lithium Battery

A solid lithium battery according to another embodiment includes: the above-described positive electrode; a negative electrode; and an electrolyte layer arranged between the positive electrode and the negative electrode, wherein the electrolyte layer includes a solid electrolyte.

Referring to FIGS. 1 to 4, a solid lithium battery 1 includes a positive electrode 10; a negative electrode 20; and an electrolyte layer 30 arranged between the positive electrode 10 and the negative electrode 20. The electrolyte layer 30 may be, for example, a solid electrolyte layer.

When a solid lithium battery employs the above-described positive electrode, leakage of a catholyte to a negative electrode is suppressed. Accordingly, side reactions of the solid lithium battery may be suppressed, and cycle characteristics may be improved.

### Positive Electrode

The above-described positive electrode is prepared.

### Electrolyte Layer

Referring to FIGS. 1 to 4, a solid lithium battery 1, and 1a includes an electrolyte layer 30, and the electrolyte layer includes a solid electrolyte. The electrolyte layer 30 may be, for example, a solid electrolyte layer. The electrolyte layer 30 may be, for example, liquid impermeable. Therefore, the catholyte may not permeate through the electrolyte layer 30.

The solid electrolyte layer may include, for example, an oxide-based solid electrolyte, a sulfide-based solid electrolyte, a halide-based solid electrolyte, or a combination thereof.

The oxide-based solid electrolyte may include, for example, lithium phosphorus oxynitride (LiPON), Li₃ₓLa_{(2/3-x)(1/3-2x)}TiO₃ (wherein 0.04<x<0.16), Li₁₊ₓAlₓTi₂₋ₓ(PO₄)₃ (wherein 0<x<2), Li₁₊ₓAlₓGe₂₋ₓ(PO₄)₃ (wherein 0<x<2), Li_{1+x+y}AlₓTi₂₋ₓSi_{y}P_{3-y}O₁₂ (wherein 0<x<2, 0≤y<3), BaTiO₃, Pb(ZrₓTi₁₋ₓ)O₃ (wherein 0≤x≤1), Pb₁₋ₓLaₓZr_{1-y}Ti_{y}O₃ (wherein 0≤x<1 and 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (wherein 0≤x≤1, 0≤y≤1, 0≤a≤1, and 0≤b≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (wherein M is Te, Nb, or Zr, and 1≤x≤10), Li₇La₃Zr₂O₁₂, Li₃₊ₓLa₃Zr₂₋ₐMₐO₁₂, (wherein M is Ga, W, Nb, Ta, or Al, 0<a<2, and 1≤x≤10), or a combination thereof. The solid electrolyte may be produced, for example, by a sintering method or the like. The oxide-based solid electrolyte may be, for example, a garnet-type solid electrolyte selected from Li₇La₃Zr₂O₁₂ (“LLZO”), and Li₃₊ₓLa₃Zr₂₋ₐMₐO₁₂ (“M doped LLZO”, wherein M=Ga, W, Nb, Ta, or Al, 0<a<2, and 1≤x≤10).

The oxide-based solid electrolyte may be, for example, crystalline, amorphous, vitreous, or a glass-ceramic. The oxide-based solid electrolyte may have various crystalline states depending on a preparation method and composition.

The sulfide-based solid electrolyte may include, for example, lithium sulfide, silicon sulfide, phosphorus sulfide, boron sulfide, or a combination thereof. Sulfide-based solid electrolyte particles may include Li₂S, P₂S₅, SiS₂, GeS₂, B₂S, or a combination thereof. Sulfide-based solid electrolyte particles may be Li₂S, or P₂S₅. Sulfide-based solid electrolyte particles are known to have higher lithium ion conductivity than other inorganic compounds. For example, a sulfide-based solid electrolyte includes Li₂S or P₂S₅. When a sulfide solid electrolyte material constituting a solid electrolyte includes Li₂S—P₂S₅, a mixing molar ratio of Li₂S to P₂S₅ may be, for example, in a range of about 50:50 to about 90:10. The sulfide-based solid electrolyte may also include inorganic solid electrolyte prepared by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄(“Thio-LISICON”), or Li₂O—Al₂O₃—TiO₂—P₂O₅ (“LATP”) to inorganic solid electrolytes of Li₂S—P₂S₅, SiS₂, GeS₂, B₂S₃, or a combination thereof. Non-limiting examples of the sulfide solid electrolyte material include Li₂S—P₂S₅; Li₂S—P₂S₅—LiX (X is a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (m and n are positive numbers, and Z is Ge, Zn, or G); Li₂S—GeS₂; Li₂S—SiS₂—Li₃PO₄; and Li₂S—SiS₂—LiₚMO_{q} (wherein in the formula, p and q are positive numbers, and M is P, Si, Ge, B, Al, Ga, or In). In this regard, the sulfide-based solid electrolyte material is prepared by processing raw starting materials (for example, Li₂S or P₂S₅) of the sulfide-based solid electrolyte material by a melt quenching method, a mechanical milling method, or the like. Also, a calcination process may be performed after the above treatment.

The halide-based solid electrolyte includes, for example, a halogen element as a main component of an anion. Including a halogen element as a main component of an anion means that a ratio (molar ratio) of the halogen element is the highest among all anions constituting the halide solid electrolyte. The ratio of the halogen (X) element with respect to all anions constituting the halide solid electrolyte may be, for example, about 50 mol % or more, about 70 mol % or more, about 90 mol % or more, or 100 mol %. One or more types of a halogen elements may be used. The halide solid electrolyte may not include, for example, an element sulfur (S). The halide solid electrolyte may include, for example, an element Li, an element M (M is a metal other than Li), and an element X. X may be, for example, F, Cl, Br, I, or combinations thereof. The halide solid electrolyte may include, for example, Br or Cl as X. The halide solid electrolyte may include, for example, metal elements such as Sc, Y, B, Al, Ga, and In as M. A composition of the halide solid electrolyte may be, for example, Li₆₋₃ₐMₐBr_{b}Cl_{c} (M is a metal other than Li, wherein 0<a<2, 0≤b≤6, 0≤c≤6, and b+c=6). The halide solid electrolyte may be, for example, Li₃YBr₆, Li₃YCl₆, or Li₃YBr₂C₁₄. The halide solid electrolyte may be, for example, particulate. An average particle diameter (D50) of the halide solid electrolyte may be, for example, about 0.05 μm to about 50 μm, or about 0.1 μm to about 20 μm. The average particle diameter (D50) of the halide solid electrolyte may be measured by, for example, a laser diffraction type particle size distribution analyzer, or a scanning electron microscope (SEM).

A solid electrolyte layer 30 may be provided in a form of, for example, a solid electrolyte sheet or a solid electrolyte thin film. Alternatively, the solid electrolyte layer may be prepared by mixing the solid electrolyte and other components.

The solid electrolyte layer 30 may be prepared, for example, by mixing and drying the above-described solid electrolyte and a binder, or by pressurizing and/or sintering the above-described solid electrolyte powder in a certain form. The solid electrolyte layer may be prepared by, for example, mixing and drying a sulfide-based, oxide-based, and/or halide-based solid electrolyte and a binder, or pressurizing and/or sintering a sulfide-based, oxide-based, and/or halide-based solid electrolyte powder into a certain form.

The solid electrolyte may be deposited by using a film formation method such as, for example, blasting, aerosol deposition, cold spraying, sputtering, chemical vapor deposition (CVD) or spraying, whereby a solid electrolyte layer may be prepared. In addition, the solid electrolyte layer may be formed by pressurizing the solid electrolyte. In addition, the solid electrolyte layer may be formed by mixing and pressurizing a solid electrolyte, a solvent, and a binder or a support. In this case, a solvent or support is added to reinforce strength of the solid electrolyte layer or to prevent a short-circuit of the solid electrolyte.

A binder included in the solid electrolyte layer may be, for example, styrene butadiene rubber (SBR), polytetrafluoroethylene, polyvinylidene fluoride, polyethylene, polyvinyl alcohol, and the like, but is not limited thereto, and any binder used in the art may be used. The binder of the solid electrolyte layer may be the same as or different from a binder of the positive electrode and/or the negative electrode.

A thickness of the electrolyte layer 30 may be, for example, 500 μm or less, 300 μm or less, 100 μm or less, or 50 μm or less. The thickness of the electrolyte layer 30 may be, for example, about 1 μm to about 500 μm, about 5 μm to about 300 μm, about 10 μm to about 100 μm, or about 10 μm to about 50 μm.

### Negative Electrode: Negative Active Material Layer

A negative electrode may include, for example, lithium metal, a lithium alloy, or a combination thereof. A thickness of the negative electrode may be smaller than that of the positive electrode. The thickness of the negative electrode may be 90% or less, 80% or less, 60% or less, or 50% or less of a thickness of the positive electrode.

Referring to FIGS. 1, 3 and 5, the negative electrode 20 includes a negative active material layer 23 arranged between a negative current collector 21 and an electrolyte layer 30. A negative active material layer 23 may include, for example, lithium metal, a lithium alloy, or a combination thereof.

The negative active material layer 23 may include, for example, a lithium foil, a lithium powder, plated lithium, a lithium alloy, or a combination thereof. The negative active material layer including a lithium foil may be, for example, a lithium metal layer. The negative active material layer including a lithium powder may be introduced by coating slurry including a lithium powder and a binder on the negative current collector. The binder may be, for example, a fluorine-based binder such as polyvinylidene fluoride (PVDF). The negative active material layer may not include a carbon-based negative active material. Thus, the negative active material layer may consist of a metal-based negative active material. The negative active material layer 23 may also be a plated lithium metal layer. A lithium alloy may include, for example, a Li—Al alloy, Li—Sn alloy, Li—In alloy, Li−Ag alloy, Li−Au alloy, Li−Zn alloy, Li—Ge alloy, Li—Si alloy, and the like, but is not limited thereto, and any used as a lithium alloy in the art may be used. After preparing a lithium battery by assembling a negative electrode 20 not including a negative active material layer 23, a positive electrode, and an electrolyte, a lithium metal layer plated between a negative current collector 21 and an interlayer 22 may be further included as a negative active material layer 23 by charging.

A thickness of the negative active material 23 may be, for example, about 0.1 micrometers (μm) to about 100 μm, about 0.1 μm to about 80 μm, about 1 μm to about 80 μm, or about 10 μm to about 80 μm, but is not limited thereto, and may be adjusted according to a type or capacity of a required solid lithium battery. When the thickness of the negative active material layer 23 is excessively increased, structural stability of the solid lithium battery may deteriorate, and side reactions may increase. When the thickness of the negative active material layer 23 is excessively decreased, energy density of the solid lithium battery may decrease. A thickness of a lithium foil may be, for example, about 1 μm to about 50 μm, about 1 μm to about 30 μm, about 10 μm to about 30 μm, or about 10 μm to about 80 μm. When the lithium foil has a thickness within these ranges, lifespan characteristics of a solid lithium battery including an interlayer may be further improved. A particle size of a lithium powder may be, for example, about 0.1 μm to about 3 μm, about 0.1 μm to about 2 μm, or about 0.1 μm to about 2 μm. When the lithium power has a particle size within these ranges, lifespan characteristics of a solid lithium battery including an interlayer may be further improved. A thickness of a plated lithium layer may be, for example, about 1 μm to about 80 μm, or about 10 μm to about 80 μm.

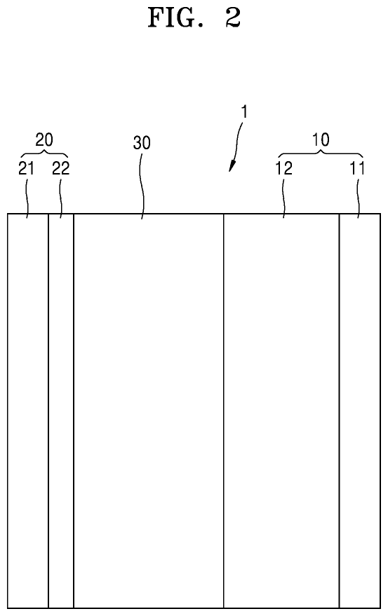

Referring to FIGS. 1 and 2, the negative active material layer 23 may be, for example, arranged between the negative current collector 21 and the interlayer 22 when assembling the solid lithium battery 1a, or may be omitted when assembling the electrode. In a solid lithium battery 1, the negative active material layer 23 may be plated between the negative current collector 21 and the interlayer 22 by charging after assembling the solid lithium battery 1. When the negative active material layer 23 is arranged between the negative current collector 21 and the interlayer 22 before the assembly of the solid lithium battery 1, the negative active material layer 23, as a metal layer including lithium metal or a lithium alloy, acts as a lithium reservoir. For example, a lithium foil is arranged between the negative current collector 21 and the negative active material layer 22 before the assembly of the solid lithium battery 1a. As a result, cycle characteristics of the solid lithium battery 1a including the negative active material layer 23 are further improved. When the negative active material layer 23 is plated by charging, after the assembly of the solid lithium battery 1a, energy density of the solid lithium battery 1a increases because the negative active material layer 23 is not included at the time the solid lithium battery 1a is assembled. For example, when the solid lithium battery 1a is charged, the battery is charged beyond charge capacity of the interlayer 22. That is, the interlayer 22 is overcharged. At an initial stage of the charging, lithium is occluded in the interlayer 22. A carbon-based material and/or a metal-based material included in the interlayer 22 may form an alloy or a compound with lithium ions transferred from the positive electrode 10. When the interlayer 22 is charged beyond its capacity, lithium is, for example, plated on a back surface of the interlayer 22, that is, between the negative current collector 21 and the interlayer 22, and the plated lithium forms the negative active material layer 23. The negative active material layer 23 is a metal layer mainly composed of lithium (that is, metal lithium). This result is obtained, for example, when the carbon-based material and/or the metal-based material included in the interlayer 22 includes a material that forms an alloy or compound with lithium. During discharging, lithium in the interlayer 22 and the negative active material layer 23, that is, the metal layers, is ionized and moves toward the positive electrode 10. In a solid lithium battery 1a, it is possible to use lithium as a negative active material. Since the interlayer 22 covers the negative active material layer 23, the interlayer 22 serves as a protective layer for the negative active material layer 23, that is, the metal layer, and at the same time suppresses deposition growth of lithium dendrites. Therefore, the interlayer 22 suppresses a short circuit and a decrease in capacity of the solid lithium battery 1a and improves cycle characteristics of the solid lithium battery 1a. When the negative active material layer 23 is arranged by charging after assembling the solid lithium battery 1a, the negative current collector 21 and the interlayer 22, and a region there between are, for example, a Li-free region where lithium (Li) is not included in an initial state or a state after discharging.

### Negative Electrode: Negative Current Collector

Referring to FIGS. 1 to 4, the negative electrode 20 includes a negative current collector 21.

The negative current collector 21 includes, for example, a first metal substrate. The first metal substrate includes a first metal as a main component or is made of the first metal. An amount of the first metal included by the first metal substrate is, for example, 90 wt % or more, 95 wt % or more, 99 wt % or more, or 99.9 wt % or more, with respect to a total weight of the first metal substrate. The first metal substrate may be composed of, for example, a material that does not react with lithium, that is, does not form an alloy and/or a compound with lithium. The first metal may be, for example, copper (Cu), nickel (Ni), stainless steel (SUS), iron (Fe), or cobalt (Co), but is not necessarily limited thereto, and any used as a current collector in the art may be used. The first metal substrate may be composed of one type of the above-described metals, or an alloy of two or more types of metals. The first metal substrate may be, for example, in a form of a sheet or a foil. A thickness of the negative current collector 21 may be, for example, about 5 μm to about 50 μm, about 10 μm to about 50 μm, about 10 μm to about 40 μm, or about 10 μm to about 30 μm, but is not necessarily limited thereto, and may be selected according to characteristics of a required lithium battery.

The negative current collector 21 may further include a coating layer (not shown) including a second metal on the first metal substrate.

The negative current collector 21 may include, for example, a first metal substrate and a coating layer arranged on the first metal substrate and including a second metal. The second metal has a higher Mohs hardness than the first metal. That is, since the coating layer including the second metal is harder than the substrate including the first metal, deterioration of the first metal substrate may be prevented. Mohs hardness of a material constituting the first metal substrate is, for example, 5.5 or less. The Mohs hardness of the first metal is, for example, 5.5 or less, 5.0 or less, 4.5 or less, 4.0 or less, 3.5 or less, or 3.0 or less. The Mohs hardness of the first metal may be, for example, about 2.0 to about 6.0. The coating layer includes a second metal. The coating layer, for example, includes a second metal as a main component or is made of the second metal. An amount of the second metal included by the coating layer is, for example, 90 wt % or more, 95 wt % or more, 99 wt % or more, or 99.9 wt % or more, with respect to a total weight of the coating layer. The coating layer may be composed of, for example, a material that does not react with lithium, that is, does not form an alloy and/or a compound with lithium. Mohs hardness of the material constituting the coating layer is, for example, 6.0 or more. For example, the Mohs hardness of the second metal is 6.0 or more, 6.5 or more, 7.0 or more, 7.5 or more, 8.0 or more, 8.5 or more, or 9.0 or more. The Mohs hardness of the second metal may be, for example, about 6.0 to about 12.0. When the Mohs hardness of the second metal is too low, it may be difficult to suppress deterioration of the negative current collector. When the Mohs hardness of the second metal is too high, processing may not be easy. The second metal is, for example, at least one selected from titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), rhodium (Rh). The coating layer may be composed of one type of the above-described metals, or an alloy of two or more types of metals. A difference in Mohs hardness between the first metal included in the first metal substrate and the second metal included in the coating layer may be, for example, 2 or more, 2.5 or more, 3 or more, 3.5 or more, or 4 or more, about 2 to about 10, about 3 to about 9, about 4 to about 8. When the first metal and the second metal have such a difference in Mohs hardness, deterioration of the negative current collector may be more effectively suppressed. The coating layer may have a single-layer structure or a multi-layer structure of two or more layers. The coating layer may have, for example, a two-layer structure including a first coating layer and a second coating layer. The coating layer may have, for example, a three-layer structure including a first coating layer, a second coating layer, and a third coating layer. A thickness of the coating layer may be, for example, about 10 nanometers (nm) to about 1 micrometer (μm), about 50 nm to about 500 nm, about 50 nm to about 200 nm, or about 50 nm to about 150 nm. When the thickness of the coating layer is too thin, it may be difficult to suppress non-uniform growth of the lithium-containing metal layer. As the thickness of the coating layer increases, cycle characteristics of the lithium battery improve, however, when the thickness of the coating layer is too thick, energy density of the lithium battery decreases, and it may not be easy to form the coating layer. The coating layer may be arranged on the first metal substrate by, for example, a vacuum deposition method, a sputtering method, a plating method, and the like, but the method is not limited thereto, and all methods used to form a coating layer in the art may be used.

### Interlayer

Referring to FIGS. 1 to 4, the negative electrode 20 further includes an interlayer 22 disposed between the current collector 21 and the electrolyte layer 30. As the negative electrode 20 includes the interlayer 22, generation and/or growth of lithium dendrites in the negative electrode 20 may be more effectively suppressed. The interlayer 22 may be omitted. A thickness of the interlayer 22 may be smaller than a thickness of the electrolyte layer 30 and a thickness of the positive electrode 10.

The interlayer 22 may include, for example, an anolyte.

The anolyte is, for example, an organic electrolyte. The organic electrolyte is prepared by, for example, dissolving a lithium salt in an organic solvent.

For the organic solvent, all that may be used as an organic solvent in the art may be used. The organic solvent may be, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, y-butyrolactone, dioxolane, 4-methyldioxolane, N,N-dimethylformamide, N,N-dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof.

For the lithium salt, any suitable lithium salt in the art may be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (1≤x≤20, 1≤y≤20), LiCl, LiI, or a mixture thereof. A concentration of a lithium salt may be, for example, about 0.1 M to about 5.0 M.

The interlayer 22 may include, for example, a separator and an anolyte impregnated into the separator.

For the separator, all that are used in a lithium battery in the art may be used. For the separator, for example, a separator having low resistance to ionic movement of the electrolyte and an excellent electrolyte impregnation ability may be used. The separator may be, for example, selected from glass fiber, polyester, polymerized tetrafluoroethylene, polyethylene, polypropylene, polytetrafluoroethylene (PTFE), or combinations thereof, and may be in a form of a nonwoven or woven fabric. For example, a winding separator such as polyethylene, polypropylene, and the like may be used in a lithium ion cell, and a separator having an excellent impregnation ability for an organic liquid electrolyte may be used in a lithium ion polymer cell.

The separator is prepared by, for example, the following example method, but a preparation method is not necessarily limited thereto, and is adjusted according to required conditions.

First, a separator composition is prepared by mixing a polymer resin, a filler, and a solvent. The separator composition is directly coated on the electrode and dried to form a separator. Alternatively, after the separator composition is casted and dried on a support, a separator film peeled from the support is laminated on an electrode to form a separator.

The polymer used for preparing the separator is not particularly limited, and any polymer used for a binder of an electrode plate may be used. For example, vinylidene fluoride/hexafluoropropylene copolymer, polyvinylidene fluoride (PVDF), polyacrylonitrile, polymethyl methacrylate, or a mixture thereof, may be used.

Alternatively, the interlayer 22 may include, for example, a carbon-based material, a metal-based material, or a combination thereof, and a binder. The interlayer 22 may not include an organic liquid electrolyte.

Carbon-based materials and metal-based materials are, for example, materials that may be lithiated and delithiated. A carbon-based material and metal-based material included in the interlayer have, for example, a particle shape. An average particle size of the carbon-based material and/or metal-based material having a particle shape may be, for example, about 10 nm to about 4 μm, about 10 nm to about 1 μm, about 10 nm to about 500 nm, about 10 nm to about 100 nm, or about 20 nm to about 80 nm. When the carbon-based material and/or metal-based material has an average particle size within these ranges, during charging and discharging, reversible plating and/or dissolution of lithium may be more facilitated. The average particle diameter of the carbon-based material and/or metal-based material is, for example, a median diameter (D50) measured by using a laser particle size distribution device.

The interlayer 22 may include, for example, at least one selected from carbon-based materials and metal-based materials. The carbon-based material may be, for example, amorphous carbon. The amorphous carbon may be, for example, carbon black (CB), acetylene black (AB), furnace black (FB), ketjen black (KB), graphene, and the like, but is not limited thereto, and all classified as amorphous carbon in the art may be used. Amorphous carbon has a very low or no crystallinity and is distinguished from crystalline carbon or graphite carbon. The metal-based material may be a metallic material or a metalloid material. The metal-based material may include, for example, at least one selected from gold (Au), platinum (Pt), palladium (Pd), silicon (Si), silver (Ag), aluminum (Al), bismuth (Bi), tin (Sn), and zinc (Zn). For example, since nickel (Ni) does not form an alloy with lithium, nickel is not a metal-based material included in the interlayer in this specification. The interlayer includes one of these carbon-based materials and metal-based materials, or a mixture thereof. The interlayer may include, for example, amorphous carbon. The interlayer may include, for example, a mixture of amorphous carbon and at least one selected from gold (Au), platinum (Pt), palladium (Pd), silicon (Si), silver (Ag), aluminum (Al), bismuth (Bi), tin (Sn), and zinc (Zn). A mixing ratio of the mixture is, for example, 10:1 to 1:2, 10:1 to 1:1, 7:1 to 1:1, 5:1 to 1:1, or 4:1 to 2:1 by weight. The interlayer may include, for example, a mixture of first particles made of amorphous carbon and second particles made of a metal or metalloid. The metal includes, for example, gold (Au), platinum (Pt), palladium (Pd), silicon (Si), silver (Ag), aluminum (AI), bismuth (Bi), tin (Sn), or zinc (Zn). An amount of the second particle is, with respect to a total weight of the mixture, about 8 wt % to about 60 wt %, about 10 wt % to about 50 wt %, about 15 wt % to about 40 wt %, or about 20 wt % to about 30 wt %. When the amount of the second particle is in these ranges, for example, cycle characteristics a lithium battery may be further improved.

A binder included in the interlayer 22 is, for example, styrene-butadiene rubber (SBR), polytetrafluoroethylene, polyvinylidene fluoride, polyethylene, vinylidene fluoride/hexafluoropropylene copolymers, polyacrylonitrile, polymethyl methacrylate, and the like, but is not limited thereto, and all used as a binder in the art may be used. The binder may be composed of one binder or multiple different binders. When the interlayer does not include a binder, the interlayer 22 may be easily separated from the electrolyte layer 30 or the negative active material layer 23. An amount of the binder included by the interlayer 22 may be, for example, about 1 wt % to about 20 wt %, with respect to a total weight of the interlayer 22.

A thickness of the interlayer 22 may be, for example, about 1 μm to about 20 μm, about 1 μm to about 15 μm, about 2 μm to about 10 μm, or about 3 μm to about 7 μm. The thickness of the interlayer 22 may be about 1% to about 50%, about 1% to about 30%, about 1% to about 10%, about 1% to about 5% of a thickness of the positive active material layer 12. When the thickness of the interlayer is too thin, lithium dendrites formed between the interlayer and the negative current collector may collapse the interlayer, making it difficult to improve cycle characteristics of the solid lithium battery. When the thickness of the interlayer is too increased, energy density of the solid lithium battery is reduced, and it may be difficult to improve cycle characteristics. When the thickness of the interlayer decreases, for example, charge capacity of the interlayer also decreases. Charge capacity of the interlayer may be, for example, about 0.1% to about 50%, about 1% to about 30%, about 1% to about 10%, about 1% to about 5%, or about 1% to about 2% of charge capacity of the positive electrode. When the charge capacity of the interlayer is too small, lithium dendrites formed between the interlayer and the negative current collector may collapse the interlayer, making it difficult to improve cycle characteristics of the lithium battery. When the charge capacity of the interlayer is too large, energy density of the lithium battery employing the negative electrode 20 is reduced, and it may be difficult to improve cycle characteristics. The charge capacity of the positive active material layer is obtained by multiplying a charge capacity density milliampere-hours per gram (mAh/g) of the positive active material to a mass of the positive active material in the positive active material layer. When multiple kinds of positive active materials are used, a value of charge capacity density×mass is calculated for each positive active material, and a total sum of the values is the charge capacity of the positive active material layer. The charge capacity of the interlayer is calculated in the same way. That is, charge capacity of the interlayer is obtained by multiplying a charging capacity density (mAh/g) of the carbon-based material and/or metallic material by a mass of the carbon-based material and/or metallic material in the interlayer. When multiple types of carbon-based materials and/or metal-based materials are used, a value of charge capacity density×mass is calculated for each material, and a sum of these values is the capacity of the interlayer. Here, the charge capacity density of the positive active material and carbon-based materials and/or metal-based materials is estimated by using an all-solid half-cell that uses lithium metal as a relative electrode. The charge capacities of the positive active material layer and the interlayer are directly measured by a charge capacity measurement using an all-solid half-cell. Charge capacity density is obtained by dividing a measured charge capacity by a mass of each active material. Alternatively, charge capacity of the positive active material layer and the interlayer may be an initial charge capacity measured during charging at the first cycle.

### Catholyte Film

According to another embodiment, a catholyte film is provided. In the catholyte film, a catholyte includes a lithium salt; an ionic liquid, and a compound represented by Formula 1, and an amount of the lithium salt is about 0.5 M to about 1.5 M, and the catholyte is a gel

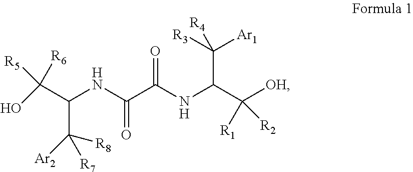

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and

Ar₁ and Ar₂ are each independently an aryl group having 5 to 20 carbon atoms, 6 to 18 carbon atoms, or 10 to 14 carbon atoms that are unsubstituted or substituted with a halogen, an aryl group having 5 to 20 carbon atoms, 6 to 18 carbon atoms, or 10 to 14 carbon atoms that are unsubstituted or substituted with an alkyl group having 1 to 3 carbon atoms, a heteroaryl group having 2 to 10 carbon atoms or 4 to 8 carbon atoms that are unsubstituted or substituted with a halogen, or a heteroaryl group having 2 to 10 carbon atoms or 4 to 8 carbon atoms that are unsubstituted or substituted with an alkyl group having 1 to 3 carbon atoms.

Since the catholyte film has a certain shape, it may be easily applied to a solid lithium battery preparation process. The catholyte film may be, for example, arranged on the positive active material layer, or between the positive active material layer and the solid electrolyte layer, and may be impregnated into the positive active material layer. Liquid catholyte may not be easily applied to a solid lithium battery preparation process.

The catholyte film may be applied to various forms of electrodes. The catholyte film may be, for example, arranged on a dry positive active material film, and impregnated into the dry positive active material film. The dry positive active material film may include, for example, a dry positive active material, a dry binder, and a dry conductive material, and the dry binder includes a fibrillized binder. The dry binder may be, for example, PTFE.

The catholyte film may be, for example, a self-standing film or a non-self-standing film.

Since a self-standing catholyte film has a film shape without a support, the catholyte film may be arranged on a positive active material layer by itself, to prepare a positive active material layer/catholyte laminate.

A non-self-standing catholyte film may be, for example, arranged on a positive active material layer in a form of being arranged on a support and a positive active material layer/catholyte laminate may be prepared by removing the support.

### Preparation Method of Positive Electrode

A method of preparing a positive electrode for a solid lithium battery includes: providing a catholyte film; arranging the catholyte film on one surface of a positive active material layer; impregnating a catholyte into the positive active material layer by liquefying the catholyte film; and gelling the catholyte impregnated in the positive active material layer, wherein the catholyte includes a lithium salt; an ionic liquid, and a compound represented by Formula 1, an amount of the lithium salt is about 0.5 M to about 1.5 M, and the catholyte is a gel

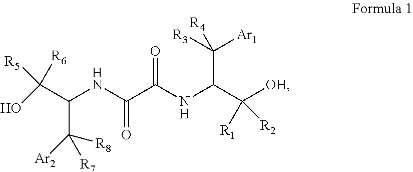

wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and

Ar₁ and Ar₂ are each independently an aryl group having 5 to 20 carbon atoms, 6 to 18 carbon atoms, or 10 to 14 carbon atoms that are unsubstituted or substituted with a halogen, an aryl group having 5 to 20 carbon atoms, 6 to 18 carbon atoms, or 10 to 14 carbon atoms that are unsubstituted or substituted with an alkyl group having 1 to 3 carbon atoms, a heteroaryl group having 2 to 10 carbon atoms or 4 to 8 carbon atoms that are unsubstituted or substituted with a halogen, or a heteroaryl group having 2 to 10 carbon atoms or 4 to 8 carbon atoms that are unsubstituted or substituted with an alkyl group having 1 to 3 carbon atoms.

First, a catholyte film is provided.

For example, preparation of a catholyte film includes preparing a composition including a lithium salt; an ionic liquid, and a compound represented by Formula 1; liquefying the composition by raising a temperature; and cooling the liquefied composition to room temperature to prepare a film in a gel state. Preparation of a composition including a lithium salt; an ionic liquid, and a compound represented by Formula 1 may be, for example, preparing by adding the lithium salt and the compound represented by Formula 1 to the ionic liquid, and mixing. By raising the temperature of the prepared composition, the composition is liquefied, and the lithium salt and the compound represented by Formula 1 are completely dissolved in the ionic liquid. The liquefied composition is again cooled to room temperature and a catholyte film in a gel state is prepared. For types and amounts of the lithium salt, ionic liquid, and compound represented by Formula 1, refer to the above-described positive electrode section.

Next, the catholyte film is arranged on one surface of the positive active material layer.

A positive active material composition is prepared by mixing a positive active material, a conductive material, a binder, and a solvent. The prepared positive active material composition is directly coated on an aluminum current collector and dried to prepare a positive electrode plate on which a positive active material layer is formed. Alternatively, the positive active material composition is cast on a separate support, and a film peeled off from the support is laminated on the aluminum current collector, to prepare a positive electrode plate on which a positive active material layer is formed. For types and amounts of the positive active material, conductive material, and binder, refer to the above-described positive electrode section. The solvent is not particularly limited and is, for example, N-methylpyrrolidone. A laminate is prepared by arranging a catholyte film on the positive active material layer.

The catholyte film may be arranged on a separately prepared positive active material layer, but is not necessarily limited to such an embodiment, and may be arranged according to various embodiments. The catholyte film may be, for example, arranged among a plurality of membrane electrode assemblies, that is, a negative electrode/solid electrolyte layer/positive electrode assembly. The catholyte film may be, for example, arranged in a laminate having an arrangement of negative electrode/solid electrolyte layer/positive electrode/catholyte film/positive electrode/solid electrolyte layer/negative electrode. The catholyte film may be, arranged between the positive electrode and the solid electrolyte layer. The catholyte film may be, for example, arranged in a laminate having an arrangement of negative electrode/solid electrolyte layer/catholyte film/positive electrode.

The catholyte film arranged on the positive active material layer may be pressurized in a direction from a top surface of the catholyte film to the positive active material layer, before being liquefied. By such pressurization, at least a portion of the catholyte film may be impregnated into the positive active material layer.

Next, the catholyte is impregnated into the positive active material by liquefying the catholyte film. The catholyte is liquefied by raising a temperature of the laminate, the catholyte is impregnated into the positive active material layer. In the process of impregnating the catholyte into the positive active material layer, vacuum may be applied to more effectively impregnate the catholyte.

Next, the catholyte impregnated in the positive active material layer is gelled. A positive electrode including a positive active material layer in which the catholyte is impregnated in a gel state is prepared by cooling the temperature of the positive active material layer in which the catholyte is impregnated, to room temperature.

Liquefaction of the catholyte film may be performed at a temperature of, for example, 80° C. or greater. In addition, gelation of the liquefied catholyte may be performed at a temperature of, for example, less than 80° C.

Hereinafter, definitions of substituents used in Formulas will be described.

The term “alkyl”, used in formulas, refers to a fully saturated branched or unbranched (or straight chain or linear) hydrocarbon.

Non-limiting examples of the “alkyl” include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, n-heptyl and the like.

One or more hydrogen atoms in the “alkyl” group may be substituted with a halogen atom, a C₁-C₃₀ alkyl group substituted with a halogen atom (for example, CF₃, CHF₂, CH₂F, or CCl₃), a C₁-C₃₀ alkoxy group, a C₂-C₃₀ alkoxyalkyl group, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, phosphoric acid or a salt thereof, or a C₁-C₃₀ alkyl group, a C₂-C₃₀ alkenyl group, a C₂-C₃₀ alkynyl group, a C₁-C₃₀ heteroalkyl group, a C₆-C₃₀ aryl group, a C₇-C₃₀ arylalkyl group, a C₂-C₃₀ heteroaryl group, a C₃-C₃₀ heteroarylalkyl group, a C₂-C₃₀ heteroaryloxy group, or a C₆-C₃₀ heteroaryloxyalkyl group.

The term “a halogen atom” includes fluorine, bromine, chlorine, iodine, and the like.

The term “C₁-C₃₀ alkyl group substituted with a halogen atom” refers to a C₁-C₃₀ alkyl group in which one or more halo groups are substituted, including, but not limited to, monohaloalkyl, dihaloalkyl, or polyhaloalkyl including perhaloalkyl.

Monohaloalkyl refers to an alkyl group having one iodine, bromine, chlorine, or fluorine in the alkyl group, and dihaloalkyl and polyhaloalkyl refer to alkyl groups having two or more identical or different halo atoms.

The term “alkoxy”, used in the formulas, refers to alkyl-O—, and the alkyl is as described above. Non-limiting examples of the alkoxy include methoxy, ethoxy, propoxy, 2-propoxy, butoxy, tert-butoxy, pentyloxy, hexyloxy, cyclopropoxy, cyclohexyloxy, and the like. One or more hydrogen atoms of the alkoxy group may be substituted with the same substituents as in the case of the above-mentioned alkyl group.

The term “aryl” group, used in the formulas, may be used alone or in combination, and refers to an aromatic hydrocarbon including one or more rings.

The term “aryl” also includes groups in which an aromatic ring is fused to one or more cycloalkyl rings.

Non-limiting examples of the “aryl” include phenyl, naphthyl, tetrahydronaphthyl, and the like.

In addition, one or more hydrogen atoms of the “aryl” group may be substituted with the same substituents as in the case of the above-mentioned alkyl group.

“Heteroaryl”, used in the formulas, means a monocyclic or bicyclic organic compound including at least one heteroatom selected from N, O, P, or S, and carbon as a remaining ring atom. The heteroaryl group may include, for example, 1 to 5 heteroatoms, and 5 to 10 ring members.

S or N may be oxidized to have various oxidation states.

Examples of monocyclic heteroaryl include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazole-5-yl, 1,2,3-triazol-4-yl, 1,2,3-triazol-5-yl, tetrazolyl, pyrid-2-yl, pyrid-3-yl, 2-pyrazine-2-yl, pyrazin-4-yl, pyrazin-5-yl, 2-pyrimidin-2-yl, 4-pyrimidin-2-yl, or 5-pyrimidin-2-yl.

The term “heteroaryl” refers to compounds in which a heteroaromatic ring is fused to at least one aryl, cycloaliphatic, or heterocycle.

Examples of bicyclic heteroaryl include indolyl, isoindolyl, indazolyl, indolizinyl, purinyl, quinolizinyl, quinolinyl, isoquinolinyl, cinnolinyl, phthalazinyl, naphthyridinyl, quinazolinyl, quinoxalinyl, phenanthridinyl, phenanthrolinyl, phenazinyl, phenothiazinyl, phenoxazinyl, benzoisoquinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, or pyrimido[4,5-d]pyrimidinyl.

One or more hydrogen atoms of the “heteroaryl” group may be substituted with the same substituents as in the case of the above-mentioned alkyl group.

Hereinafter, the disclosure will be described in detail with reference to examples and comparative examples but is not limited to the following examples.

### EXAMPLES

### Preparation of Catholyte

### Preparation Example 1

A compound represented by Formula 3 ((S,S)-bis(phenylalaninol)oxalyl amide) as a gelling agent, and 1.0 M of LiN(SO₂F)₂ (LIFSI) as a lithium salt were added to an ionic liquid of Pyr₁₃FSI(N-propyl-N-methyl-pyrrolidinium bis(fluorosulfonyl)imide) in a test tube, to prepare a mixture. The mixture was heated to 90° C. to completely dissolve the gelling agent and lithium salt, and then cooled to room temperature to prepare a catholyte. An amount of the compound represented by Formula 3 in the catholyte was 8 wt %.

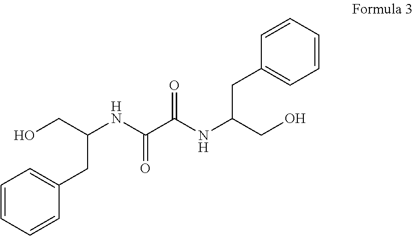 [SMILES: O=C(NC(CO)Cc1ccccc1)C(=O)NC(CO)Cc1ccccc1]

### Preparation Example 2

A catholyte was prepared in the same way as in Preparation Example 1, except that a concentration of the lithium salt was changed to 0.5 M.

### Preparation Example 3

A catholyte was prepared in the same way as in Preparation Example 1, except that a concentration of the lithium salt was changed to 1.5 M.

### Comparative Preparation Example 1

A catholyte was prepared in the same way as in Preparation Example 1, except that the lithium salt was not added.

### Comparative Preparation Example 2

A catholyte was prepared in the same way as in Preparation Example 1, except that a concentration of the lithium salt was changed to 0.1 M.

### Comparative Preparation Example 3

A catholyte was prepared in the same way as in Preparation Example 1, except that a concentration of the lithium salt was changed to 2.0 M.

### Reference Preparation Example A1

A catholyte was prepared in the same way as in Preparation Example 1, except that a compound represented by Formula A ((S,S)-bis(phenylalanine)oxalyl amide) was used instead of the compound represented by Formula 3, as a gelling agent.

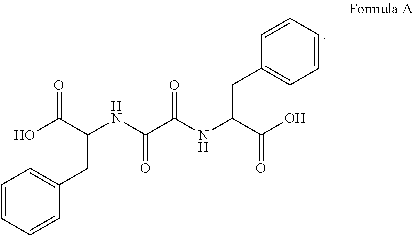 [SMILES: O=C(NC(Cc1ccccc1)C(=O)O)C(=O)NC(Cc1ccccc1)C(=O)O]

### Reference Preparation Example A2

A catholyte was prepared in the same way as in Reference Preparation Example A1, except that a concentration of the lithium salt was changed to 0.5 M.

### Reference Preparation Example A3

A catholyte was prepared in the same way as in Reference Preparation Example A1, except that a concentration of the lithium salt was changed to 1.5 M.

### Comparative Preparation Example A1

A catholyte was prepared in the same way as in Reference Preparation Example A1, except that the lithium salt was not added.

### Comparative Preparation Example A2

A catholyte was prepared in the same way as in Reference Preparation Example A1, except that a concentration of the lithium salt was changed to 0.1 M.

### Comparative Preparation Example A3

A catholyte was prepared in the same way as in Reference Preparation Example A1, except that a concentration of the lithium salt was changed to 2.0 M.

### Reference Preparation Example B1

A catholyte was prepared in the same way as in Preparation Example 1, except that a compound represented by Formula B ((S,S)-bis(leucinol)oxalyl amide) was used instead of the compound represented by Formula 3, as a gelling agent.

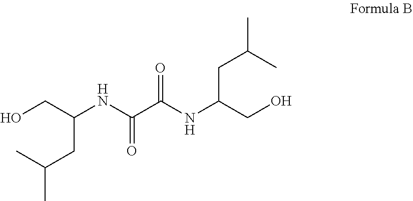 [SMILES: CC(C)CC(CO)NC(=O)C(=O)NC(CO)CC(C)C]

### Reference Preparation Example B2

A catholyte was prepared in the same way as in Reference Preparation Example B1, except that a concentration of the lithium salt was changed to 0.5 M.

### Reference Preparation Example B3

A catholyte was prepared in the same way as in Reference Preparation Example B1, except that a concentration of the lithium salt was changed to 1.5 M.

### Comparative Preparation Example B1

A catholyte was prepared in the same way as in Reference Preparation Example B1, except that the lithium salt was not added.

### Comparative Preparation Example B2

A catholyte was prepared in the same way as in Reference Preparation Example B1, except that a concentration of the lithium salt was changed to 0.1 M.

### Comparative Preparation Example B3

A catholyte was prepared in the same way as in Reference Preparation Example B1, except that a concentration of the lithium salt was changed to 2.0 M.

### Reference Preparation Example C1

A catholyte was prepared in the same way as in Preparation Example 1, except that a compound represented by Formula C ((S,S)-bis(leucine)oxalyl amide) was used instead of the compound represented by Formula 3, as a gelling agent.

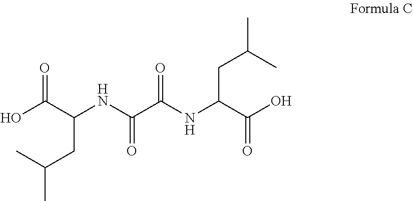 [SMILES: CC(C)CC(NC(=O)C(=O)NC(CC(C)C)C(=O)O)C(=O)O]

### Reference Preparation Example C2

A catholyte was prepared in the same way as in Reference Preparation Example C1, except that a concentration of the lithium salt was changed to 0.5 M.

### Reference Preparation Example C3

A catholyte was prepared in the same way as in Reference Preparation Example C1, except that a concentration of the lithium salt was changed to 1.5 M.

### Comparative Preparation Example C1

A catholyte was prepared in the same way as in Reference Preparation Example C1, except that the lithium salt was not added.

### Comparative Preparation Example C2

A catholyte was prepared in the same way as in Reference Preparation Example C1, except that a concentration of the lithium salt was changed to 0.1 M.

### Comparative Preparation Example C3

A catholyte was prepared in the same way as in Reference Preparation Example C1, except that a concentration of the lithium salt was changed to 2.0 M.

States of catholytes at room temperature (25° C.) were shown in Table 1, wherein the catholytes were prepared in Preparation Examples 1 to 3, Comparative Preparation Examples 1 to 3, Reference Preparation Examples A1 to A3, Comparative Preparation Examples A1 to A3, Reference Preparation Examples B1 to B3, Comparative Preparation Examples B1 to B3, Reference Preparation Examples C1 to C3, and Comparative Preparation Examples C1 to C3. It was confirmed that a stable gel-state catholyte was not obtained, except in Preparation Examples 1 to 3.

A state of catholyte is classified as follows. “Gel” is in a state of very low flowability. A catholyte in a gel state may substantially not change its shape for 24 hours at 25° C. on a substrate tilted at 45° from a horizontal surface. “Gel” is in a state of a single phase.

“Soluble” is a liquid state. The catholyte in a soluble state has very high flowability.

“Partially soluble” is a state of a mixed solution of a gel and a liquid, wherein an amount of the gel is greater than an amount of the liquid. A partially soluble catholyte has low flowability.

“Unstable” is a state of a mixed solution of a gel and a liquid, wherein an amount of the gel is smaller than an amount of the liquid. The state of a mixed solution of a gel and a liquid and has a low gel content, has high flowability.

TABLE 1

| Example | State of catholyte |
|---|---|
| Preparation Example 1 | Gel |
| Preparation Example 2 | Gel |
| Preparation Example 3 | Gel |
| Comparative Preparation Example 1 | Partially soluble |
| Comparative Preparation Example 2 | Partially soluble |
| Comparative Preparation Example 3 | Soluble |
| Reference Preparation Example A1 | Soluble |
| Reference Preparation Example A2 | Soluble |
| Reference Preparation Example A3 | Soluble |
| Comparative Preparation Example A1 | Soluble |
| Comparative Preparation Example A2 | Soluble |
| Comparative Preparation Example A3 | Soluble |
| Reference Preparation Example B1 | Unstable phase |
| Reference Preparation Example B2 | Soluble |
| Reference Preparation Example B3 | Soluble |
| Comparative Preparation Example B1 | Unstable phase |
| Comparative Preparation Example B2 | Partially soluble |
| Comparative Preparation Example B3 | Soluble |
| Reference Preparation Example C1 | Unstable phase |
| Reference Preparation Example C2 | Unstable phase |
| Reference Preparation Example C3 | Unstable phase |
| Comparative Preparation Example C1 | Unstable phase |
| Comparative Preparation Example C2 | Unstable phase |
| Comparative Preparation Example C3 | Unstable phase |

### Example 1

### Preparation of Positive Electrode

A catholyte film in a gel state was prepared by liquefying the catholyte prepared in Preparation Example 1 at a temperature of 80° C. or greater, coating the catholyte on a substrate, and then cooling to room temperature.

LiNi_{0.80}Co_{0.15}Al_{0.05}O₂ (NCA) was prepared as a positive active material. Carbon black (Cabot) and graphite (SFG6, Timcal) were prepared as conductive materials. Polytetrafluoroethylene (PTFE) was prepared as a binder. A mixture was prepared by mixing the positive active material: carbon black: graphite: binder in a mass ratio of 93:3:1:3. The mixture was stretched into a sheet form to prepare a positive active material layer sheet. The positive active material layer sheet was compressed on a positive current collector composed of an aluminum foil having a thickness of 12 μm, to prepare a positive electrode.

A laminate was prepared by arranging the catholyte film on the positive active material layer. A temperature of the laminate was raised to 80° C. in a vacuum oven and then the vacuum was released. As the gel-state catholyte sheet was liquefied, the catholyte was impregnated into the positive active material layer. The temperature of the laminate was cooled to room temperature to prepare a positive electrode including a gel-state catholyte. Since the catholyte had a gel state, there was no leakage of the catholyte from the positive active material layer even when the positive electrode was tilted vertically.

### Preparation of Laminate of Solid Electrolyte Layer/Interlayer/Negative Electrode

Li_{6.5}La₃Zr_{1.5}Ta_{0.5}O₁₂, (LLZO) pellets (Li_{6.5}La₃Zr_{1.5}Ta_{0.5}O₁₂, Toshima, Japan) were prepared as a solid electrolyte layer.

The separator (Celgard 3501) was arranged on the solid electrolyte layer.

An interlayer was prepared by injecting 0.2 mL of a liquid electrolyte into the separator, wherein in the liquid electrolyte, 1.0 M of lithium bis(fluorosulfonyl)imide (LiFSI) was dissolved in propylene carbonate (PC).

A laminate of a solid electrolyte layer/an interlayer/a negative electrode was prepared by arranging a laminate of a negative electrode/a negative current collector on a separator, wherein the laminate of a negative electrode/a negative current collector is composed of a lithium-copper (Li—Cu) foil in which 20 μm-thick lithium metal is coated on a 10 μm-thick copper foil.

### Preparation of Solid Lithium Battery

A positive electrode was arranged on a solid electrolyte layer of a laminate of a solid electrolyte layer/an interlayer/a negative electrode, to prepare a solid lithium battery coin cell.

The positive electrode, the negative electrode, and the interlayer were arranged in the central portion of the solid electrolyte layer. A diameter of the solid electrolyte layer was 50% or more larger than diameters of the positive electrode, the negative electrode, and the interlayer.

### Examples 2 and 3

Solid lithium batteries were prepared in the same way as in Example 1, except that catholytes prepared in Preparation Examples 2 and 3 were respectively used.

### Comparative Examples 1 to 3

Solid lithium batteries were prepared in the same way as in Example 1, except that catholytes prepared in Comparative Preparation Examples 1 to 3 were respectively used.

### Evaluation Example 1: Charge/Discharge Test

Charge/discharge characteristics of solid lithium batteries prepared in Example 1 and Comparative Example 1 were evaluated by the following charge/discharge test. The charge/discharge test was performed on the solid lithium batteries at 25° C.

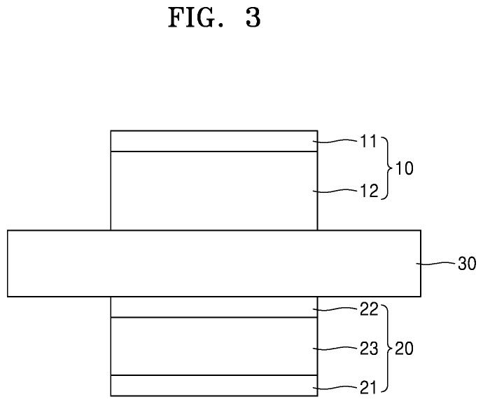

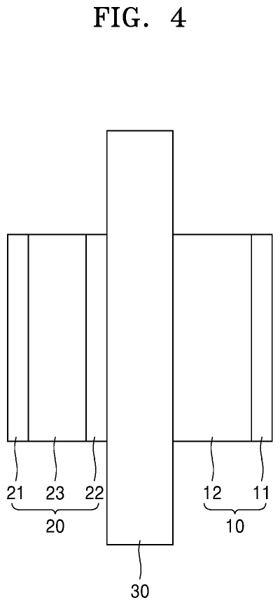

The solid lithium batteries of Example 1 and Comparative Example 1 were arranged such that the solid electrolyte layer was arranged horizontally on the ground, and a charge/discharge test was performed. In Comparative Example 1-1, a charge/discharge test was performed on the solid lithium battery of Comparative Example 1 with the solid electrolyte layer tilted at 90 degrees so as to be perpendicular to the ground. The solid lithium batteries of Example 1 and Comparative Example 1 have an arrangement of FIG. 3. The solid lithium battery of Comparative Example 1-1 has an arrangement of FIG. 4.

For the first cycle, the battery was charged at a constant current of 0.3 milliampere per square centimeter (mA/cm²) until the battery voltage reached 4.3 volts (V), and then, the battery was charged at a constant voltage until an amount of the current was reduced to 0.03 mA/cm². Subsequently, the battery was discharged at a constant current of 0.3 mA/cm² until the battery voltage reached 2.85 V.

For the 2nd to 4th cycles, the battery was charged at a constant current of 0.5 mA/cm² until the battery voltage reached 4.3 V, and then, the battery was charged at a constant voltage until an amount of the current was reduced to 0.05 mA/cm². Subsequently, the battery was discharged at a constant current of 0.5 mA/cm² (0.1 C) until the battery voltage reached 2.85 V.

For the 5th to 7th cycles, the battery was charged at a constant current of 1 mA/cm² (0.2 C) until the battery voltage reached 4.3 V, and then, the battery was charged at a constant voltage until an amount of the current was reduced to 0.1 mA/cm². Subsequently, the battery was discharged at a constant current of 1.0 mA/cm² (0.2 C) until the battery voltage reached 2.85 V.

For the 8th to 10th cycles, the battery was charged at a constant current of 2.0 mA/cm² (0.4 C) until the battery voltage reached 4.3 V, and then, the battery was charged at a constant voltage until an amount of the current was reduced to 0.2 mA/cm². Subsequently, the battery was discharged at a constant current of 2.0 mA/cm² (0.4 C) until the battery voltage reached 2.85 V.

For the 11th to 13th cycles, the battery was charged at a constant current of 2.5 mA/cm² (0.5 C) until the battery voltage reached 4.3 V, and then, the battery was charged at a constant voltage until an amount of the current was reduced to 0.25 mA/cm². Subsequently, the battery was discharged at a constant current of 2.5 mA/cm² (0.5 C) until the battery voltage reached 2.85 V.

After each charge/discharge process, there was a rest period of 10 minutes.

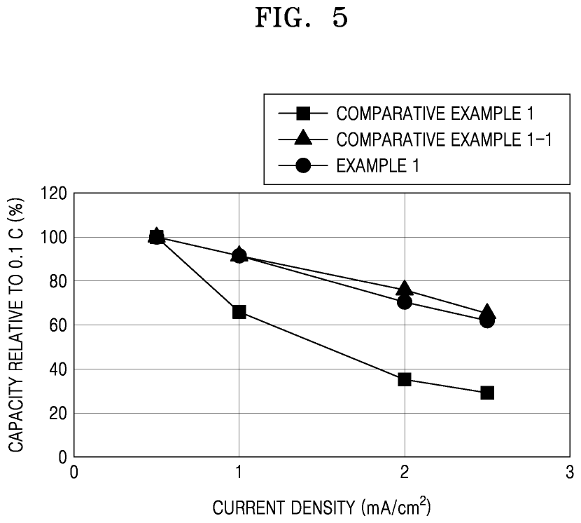

Some of results of the charge/discharge test are shown in Table 2 below and FIG. 5.

In Table 2, 0.2 C/0.1 C×100% is a ratio of an average discharge capacity in the 5th to 7th cycles charged and discharged at a constant current of 0.2 C, and an average discharge capacity in the 2nd to 4th cycles charged and discharged at a constant current of 0.1 C.

In Table 2, 0.4 C/0.1 C×100% is a ratio of an average discharge capacity in the 8th to 10th cycles charged and discharged at a constant current of 0.4 C, and an average discharge capacity in the 2nd to 4th cycles charged and discharged at a constant current of 0.1 C.

In Table 2, 0.5 C/0.1 C×100% is a ratio of an average discharge capacity in the 11th to 13th cycles charged and discharged at a constant current of 0.5 C, and an average discharge capacity in the 2nd to 4th cycles charged and discharged at a constant current of 0.1 C.

A C rate is a current which will discharge a battery in one hour, e.g., a C rate for a battery having a discharge capacity of 1.6 ampere-hours would be 1.6 amperes.

TABLE 2

| | Average discharge | Average discharge | Average discharge |
|---|---|---|---|
| | capacity of 5th to | capacity of 8th to | capacity of 11th to |
| | 7th cycles/average | 10th cycles/average | 13th cycles/average |
| | discharge capacity | discharge capacity | discharge capacity |
| | of 2th to 4th | of 2th to 4th | of 2th to 4th |
| | cycles × 100% | cycles × 100% | cycles × 100% |
| | (0.2 C/0.1 C × 100%) | (0.4 C/0.1 C × 100%) | (0.5 C/0.1 C × 100%) |
| Comparative | 65 | 35 | 29 |
| Example 1 | | | |
| Comparative | 91 | 76 | 65 |
| Example 1-1 | | | |
| Example 1 | 91 | 70 | 61 |

As shown in Table 2 and FIG. 5, a solid lithium battery including a catholyte of Example 1 in a gel state has markedly enhanced high-rate characteristics, compared to a solid lithium battery including a catholyte of Comparative Example 1 in a liquid state.

The solid lithium battery of Example 1 exhibited high-rate characteristics similar to that of the solid lithium battery of Comparative Example 1-1, which was arranged vertically in order to suppress deterioration of the negative electrode by the catholyte in a liquid state.

As the solid lithium battery of Example 1 employs a catholyte in a gel state, it was confirmed that deterioration due to contact between the catholyte and the negative electrode was suppressed.

As described above, a solid lithium battery related to the present example may be applied to various portable devices or vehicles.

Example embodiments have been described in detail with reference to the accompanying drawings, but the disclosure is not limited to these examples. It is obvious that a person with ordinary knowledge in the technical field to which this disclosure belongs may derive various changes or modifications within the scope of the technical idea described in the claims, and these are, of course, within the technical scope of the creative idea.

According to an aspect, a positive electrode and a solid lithium battery including the same are provided, the positive electrode providing excellent cycle characteristics by suppressing side reactions between a catholyte and a negative electrode.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A positive electrode for a solid lithium battery, comprising:
a positive active material; and
a catholyte,
wherein the catholyte comprises a lithium salt, an ionic liquid, and a compound represented by Formula 1,
an amount of the lithium salt is about 0.5 moles per liter to about 1.5 moles per liter, and
the catholyte is a gel 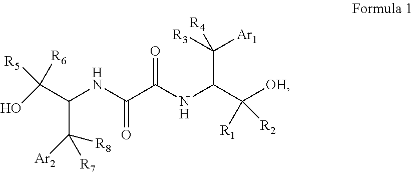
wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

2. The positive electrode of claim 1, wherein the catholyte is liquid at a temperature of 80° C. or greater.

3. The positive electrode of claim 1, wherein the compound represented by Formula 1 is a compound represented by Formula 2: 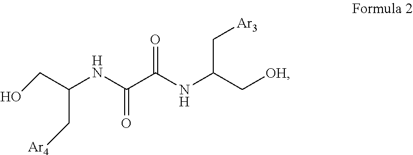
wherein in Formula 2, Ar₃ and Ar₄ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

4. The positive electrode of claim 1, wherein the compound represented by Formula 1 is a compound represented by a compound of Formulas 3 to 10, or a combination thereof

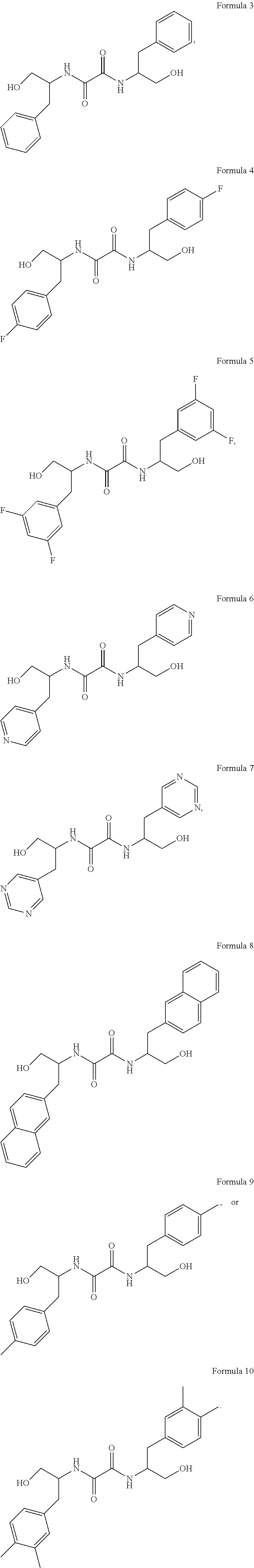

5. The positive electrode of claim 1, wherein an amount of the compound represented by Formula 1 is about 2 weight percent to about 10 weight percent, with respect to a total weight of the catholyte.

6. The positive electrode of claim 1, wherein the lithium salt comprises LiPF₆, LiBF₄, LiCF₃SO₃, LiC₂F₅SO₃, LiC₄F₉SO₃, LiN(SO₂F)₂, LiN(CF₃SO₂)₂, LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, compounds represented by Formulas 11 to 14, or a combination thereof:

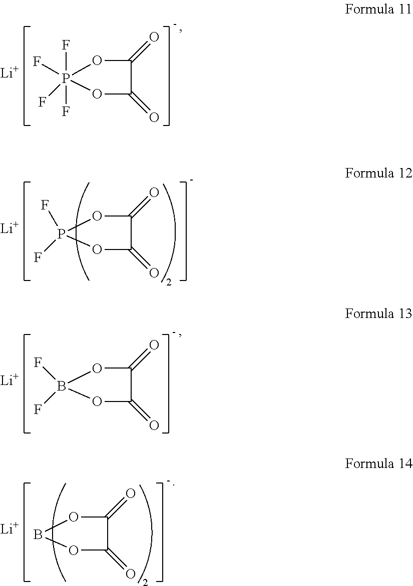

7. The positive electrode of claim 1, wherein an amount of the lithium salt is about 0.3 moles per liter to about 1.2 moles per liter.

8. The positive electrode of claim 1, wherein the ionic liquid comprises compounds represented by Formulas 15, 16, or a combination thereof: 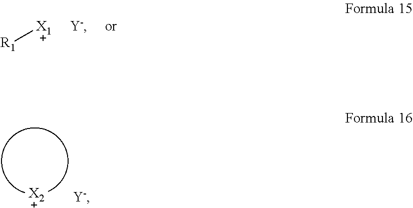
wherein in Formula 15,
X₁ is —N(R₂)(R₃)(R₄) or —P(R₂)(R₃)(R₄); and
R₁, R₂, R₃, and R₄ are each independently a C1-C30 alkyl group unsubstituted or substituted with a halogen, a C1-C30 alkoxy group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, and a C2-C100 alkylene oxide group unsubstituted or substituted with a halogen, and
in Formula 16, 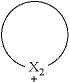
is a heterocycloalkyl ring or heteroaryl ring containing 1 to 3 heteroatoms and 2 to 30 carbon atoms, the ring being unsubstituted, or substituted by a substituent;
X₂ is —N(R₅)(R₆), —N(R₅)═, —P(R₅)(R₆), or —P(R₅)═;
The substituent with which the ring is substituted, R₅, and R₆ are each independently hydrogen, a C1-C30 alkyl group unsubstituted or substituted with a halogen, a C1-C30 alkoxy group unsubstituted or substituted with a halogen, a C6-C30 aryl group unsubstituted or substituted with a halogen, a C6-C30 aryloxy group unsubstituted or substituted with a halogen, a C3-C30 heteroaryl group unsubstituted or substituted with a halogen, a C3-C30 heteroaryloxy group unsubstituted or substituted with a halogen, a C4-C30 cycloalkyl group unsubstituted or substituted with a halogen, a C3-C30 heterocycloalkyl group unsubstituted or substituted with a halogen, and a C2-C100 alkylene oxide group unsubstituted or substituted with a halogen; and
Y⁻ is an anion.

9. The positive electrode of claim 1, wherein the ionic liquid comprises compounds represented by Formulas 17,18, or a combination thereof: 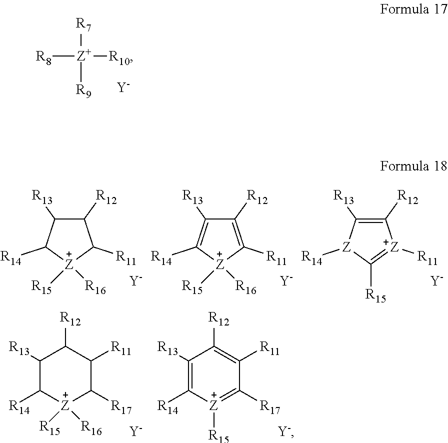
wherein in Formula 17,
Z is N or P; and
R₇, R₈, R₉, and Rio are each independently a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen, and
in Formula 18,
Z is N or P; and
R₁₁, R₁₂, R₁₃, R₁₄, R₁₅, R₁₆, and R₁₇ are each independently hydrogen, a C1-C30 alkyl group unsubstituted or substituted with a halogen, a C6-C30 aryl group unsubstituted or substituted with a halogen, a C3-C30 heteroaryl group unsubstituted or substituted with a halogen, a C4-C30 cycloalkyl group unsubstituted or substituted with a halogen, or a C3-C30 heterocycloalkyl group unsubstituted or substituted with a halogen; and
Y⁻ is an anion.

10. The positive electrode of claim 8, wherein the anion comprises BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, bis(oxalate)borate, CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

11. The positive electrode of claim 1, wherein the ionic liquid comprises 1-methyl-1-propylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, or a combination thereof.

12. The positive electrode of claim 1, wherein the catholyte is free of an oligomer, a polymer, or a combination thereof, having a molecular weight of 1,000 Daltons or greater,
the catholyte is free of a non-aqueous solvent, or
the positive electrode is free of an inorganic solid electrolyte.

13. A solid lithium battery comprising:
the positive electrode according to claim 1;
a negative electrode; and
an electrolyte layer arranged between the positive electrode and the negative electrode,
wherein the electrolyte layer comprises a solid electrolyte.

14. The solid lithium battery of claim 13, wherein the electrolyte layer is liquid impermeable.

15. The solid lithium battery of claim 13, wherein the electrolyte layer comprises an oxide-based solid electrolyte,
the oxide-based solid electrolyte comprises lithium phosphorus oxynitride, Li₃ₓLa_{(2/3-x)(1/3-2x)}TiO₃ (wherein 0.04<x<0.16), Li₁₊ₓAlₓTi₂₋ₓ(PO₄)₃ (wherein 0<x<2), Li₁₊ₓAlₓGe₂₋ₓ(PO₄)₃ (wherein 0<x<2), Li_{1+x+y}AlₓTi₂₋ₓSi_{y}P_{3-y}O₁₂ (wherein 0<x<2 and 0≤y<3), BaTiO₃, Pb(ZrₓTi₁₋ₓ)O₃ (wherein 0≤x≤1), Pb₁₋ₓLaₓZr_{1-y}Ti_{y}O₃ (wherein 0≤x<1 and 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Tiz(PO₄)₃ (wherein 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (wherein 0≤x≤1, 0≤y≤1, 0≤a≤1, and 0≤b≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (wherein M is Te, Nb, or Zr, and 1≤x≤10), Li₇La₃Zr₂O₁₂, Li₃₊ₓLa₃Zr₂₋ₐMₐO₁₂, (wherein M is Ga, W, Nb, Ta, or Al, 0<a<2, and 1≤x≤10), or a combination thereof,
the oxide-based solid electrolyte is crystalline, amorphous, vitreous, or a glass-ceramic, and
a thickness of the electrolyte layer is 100 micrometers or less.

16. The solid lithium battery of claim 13, wherein the negative electrode comprises lithium metal, a lithium alloy, or a combination thereof, and
a thickness of the negative electrode is smaller than a thickness of the positive electrode.

17. The solid lithium battery of claim 13, further comprising an interlayer arranged between the negative electrode and the electrolyte layer, wherein a thickness of the interlayer is smaller than a thickness of the electrolyte layer or a thickness of the positive electrode.

18. The solid lithium battery of claim 17, wherein the interlayer comprises an anolyte, or the interlayer comprises a carbon-based material, a metal-based material, or a combination thereof, and a binder.

19. A method of preparing a positive electrode for a solid lithium battery, the method comprising:
providing a catholyte film;
arranging the catholyte film on one surface of a positive active material layer;
liquefying the catholyte film to impregnate the positive active material layer with the catholyte and form an impregnated positive active material; and
cooling the impregnated positive active material to gel the catholyte impregnated in the positive active material layer and prepare the positive active material,
wherein the catholyte comprises
a lithium salt, an ionic liquid, and a compound represented by Formula 1,
an amount of the lithium salt is about 0.5 moles per liter to about 1.5 moles per liter, and
the catholyte is a gel 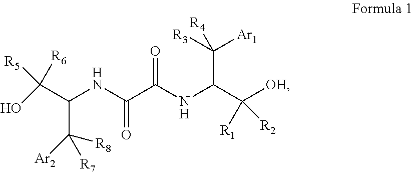
wherein in Formula 1, R₁, R₂, R₃, R₄, R₅, R₆, R₇, and R₈ are each independently an alkyl group having 1 to 3 carbon atoms that are unsubstituted or substituted with hydrogen or a halogen, and
Ar₁ and Ar₂ are each independently an aryl group having 5 to 20 carbon atoms that are unsubstituted or substituted with a halogen, an aryl group having 5 to 20 carbon atoms that are unsubstituted or substituted with an alkyl group having 1 to 3 carbon atoms, a heteroaryl group having 2 to 10 carbon atoms that are unsubstituted or substituted with a halogen, or a heteroaryl group having 2 to 10 carbon atoms that are unsubstituted or substituted with an alkyl group having 1 to 3 carbon atoms.

20. The method of claim 19, wherein the liquefaction of the catholyte film is performed at a temperature of 80° C. or greater, and
the gelation of the catholyte is performed at a temperature of less than 80° C.
